(19) United States
(12) Patent Application Publication
(10) Pub. No.: US 2014/0108585 A1
(43) Pub. Date: Apr. 17, 2014

(54) MULTIMEDIA CONTENT MANAGEMENT SYSTEM

(71) Applicant: InVisioneer, Inc., San Jose, CA (US)

(72) Inventors: James M. Barton, Los Gatos, CA (US); Michael Ramsay, San Jose, CA (US); Jill Huchital, San Jose, CA (US); Wijnand van Stam, Sunnyvale, CA (US); William Todd Stinson, Pacifica, CA (US); Anton Kast, San Francisco, CA (US); Nida Zada, San Jose, CA (US); Ching Tong Chow, Los Altos, CA (US); Jonathan Mendelson, San Jose, CA (US)

(73) Assignee: InVisioneer, Inc., San Jose, CA (US)

(21) Appl. No.: 14/053,597

(22) Filed: Oct. 14, 2013

Related U.S. Application Data
(60) Provisional application No. 61/714,072, filed on Oct. 15, 2012.
(60) Provisional application No. 61/774,191, filed on Mar. 7, 2013.

(51) Int. Cl. G06F 15/167

(52) U.S. Cl. CPC G06F 15/167
USPC 709/213

(57) ABSTRACT

A system allows a user to select multimedia content items from sources that include, but are not limited to, any of: Internet, network, or local. Selected multimedia content items may be stored in user specific caches residing in at least one cloud based storage device. Multimedia content items may be transcoded while or after being retrieved from a source and then stored in a user specific cache. Multimedia content items may be selected by a user from the user's specific cache and streamed to a user device.

### CROSS REFERENCE TO RELATED APPLICATIONS

This application claims benefit as a non-Provisional Application of U.S. Provisional Patent Application Ser. No. 61/714,072, filed on Oct. 15, 2012 and further claims benefit as a non-Provisional Application of U.S. Provisional Patent Application Ser. No. 61/774,191, filed on Mar. 7, 2013, the entire contents of the aforementioned applications are incorporated herein by reference.

### TECHNOLOGY

The present invention relates generally to the distribution and management of multimedia content, and in particular, to distributing and managing multimedia content among highly connected multimedia devices.

### BACKGROUND

Modern consumers have available to them an expanding catalog of multimedia content for their entertainment and education available from many different Internet-based outlets. At the same time, these consumers wish to experience this multimedia content on any of their personal multimedia consumption devices, e.g., televisions, handheld tablets, smartphones, etc. The modern consumer has many such devices, and may wish to consume the multimedia content available to them on whichever device they have at hand, or to direct it to particular devices for later consumption.

The consumer's desire for this level of flexibility has been thwarted by many factors. First, the various outlets from which interesting multimedia content is available typically attempt to make “walled gardens” for the consumption of this content, where the consumer is forced to undergo the outlet's constrained and controlled experience. For example, Hulu forces the consumer to use their website or application for viewing videos, whence the company can force the consumer to view advertising, whether it be traditional television-style commercials or banner advertisements.

Second, many of the producers of interesting multimedia content take pains to control consumption and prescribe the consumers ability to make use of the content. For example, Netflix content is protected from access via proprietary encryption protocols and Digital Rights Management (DRM) restrictions, and can only be viewed through applications supporting these protocols and enforcing these restrictions.

Third, although some outlets permit consumption of purchased multimedia content across different devices, the range of devices is usually limited to those of a particular manufacture or software provider. For example, multimedia content purchased through Apple iTunes can only be consumed on Apple devices or through the iTunes application, which is limited to the Microsoft Windows software platform.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates a block diagram of system components, according to an embodiment of the invention;

FIG. 2 illustrates a block diagram of a metadata scraping component, according to an embodiment of the invention;

FIGS. 3a and 3b illustrate a block diagram of cache management components, according to an embodiment of the invention;

FIG. 4 illustrates a block diagram of a streaming agent, according to an embodiment of the invention;

FIG. 5 illustrates a block diagram of an ATSC tuner in a user's home communicating with a streaming agent, according to an embodiment of the invention;

FIG. 6 illustrates a block diagram of system components, according to an embodiment of the invention;

FIG. 7 illustrates a block diagram of server components, according to an embodiment of the invention;

FIG. 8 illustrates an Experience Delivery Device (EDD), according to an embodiment of the invention;

FIG. 9 illustrates an EDD in communication with a user device, according to an embodiment of the invention;

FIG. 10 illustrates user interface display screens, according to an embodiment of the invention;

FIG. 11 illustrates components for managing user devices, according to an embodiment of the invention;

FIG. 12 illustrates a user interface display screen, according to an embodiment of the invention;

FIG. 13 illustrates a user interface display screen, according to an embodiment of the invention;

FIG. 14 illustrates a user interface display screen, according to an embodiment of the invention;

FIG. 15 illustrates a user interface display screen, according to an embodiment of the invention;

FIG. 16 illustrates a manual EDD configuration communication sequence involving light detection, according to an embodiment of the invention;

FIG. 17 illustrates a Web interface EDD configuration communication sequence, according to an embodiment of the invention;

FIG. 18 illustrates a user interface display screen, according to an embodiment of the invention; and

FIG. 19 illustrates an example hardware platform on which a computer or a computing device as described herein may be implemented.

### DESCRIPTION OF EXAMPLE EMBODIMENTS

Example embodiments, which relate to distribution and management of multimedia content, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1. GENERAL OVERVIEW
2. CONTENT SEARCH
3. CONTENT DESCRIPTOR CREATION AND MANAGEMENT
4. VIDEO CACHING TO THE PERSONAL CACHE
5. STREAMING AGENT
6. ATSC BROADCAST CONTENT TRANSFER TO THE STREAMING AGENT
7. HANDLING PERSONAL MULTIMEDIA CONTENT
   7.1 USER DEVICES
   7.2 FUNCTIONS IMPLEMENTED WITHIN A USER DEVICE
   7.3 FUNCTIONS IMPLEMENTED WITHIN THE EXPERIENCE DELIVERY DEVICE (EDD)
      7.3.1 PLAYBACK OF A SINGLE VIDEO
      7.3.2 PLAYBACK CONTROL AND REPORTING
      7.3.3 MULTI-VIDEO PLAYBACK
      7.3.4 EDDS AND SOCIAL NETWORKING
      7.3.5 CONFIGURING AN EDD
   7.4 DISCOVERY OF EDDS IN CERTAIN ENVIRONMENTS
   7.5 FUNCTIONS IMPLEMENTED IN THE MANAGEMENT SERVER
8. OPTIMIZATION AND CACHING MANAGEMENT
9. USER AND DEVICE REGISTRATION
10. SECURING CACHED CONTENT
11. IMPLEMENTATION MECHANISMS—HARDWARE OVERVIEW
12. EQUIVALENTS, EXTENSIONS, ALTERNATIVES AND MISCELLANEOUS

### 1. General Overview

This overview presents a basic description of some aspects of an embodiment of the present invention. It should be noted that this overview is not an extensive or exhaustive summary of aspects of the embodiment. Moreover, it should be noted that this overview is not intended to be understood as identifying any particularly significant aspects or elements of the embodiment, nor as delineating any scope of the embodiment in particular, nor the invention in general. This overview merely presents some concepts that relate to the example embodiment in a condensed and simplified format, and should be understood as merely a conceptual prelude to a more detailed description of example embodiments that follows below.

An embodiment of the invention enables the user to find interesting video in ways that cut through the noise of the many thousands of choices he is presented with across the Internet. Integration of the user's social network, whether expressed through Facebook, Twitter, YouTube, or other mechanisms, into searches across the many available specialized and general purpose databases can greatly simplify finding the right media to watch or listen to, in real time.

An embodiment of the invention includes a single system that automatically collects and categorizes information about the vast choices of content available to the consumer, and uses real-time information from sources such as social networks and ratings and classification services to narrow and customize this information for easy perusal by the user.

In an embodiment, on request by the user or using user preference settings, the system can automatically cache particular video of interest in user-dedicated server-based storage accessible via the Internet. This caching enables the user to watch the cached video of interest at the time of his choosing, using a carefully managed interface that gives full control over the playback experience. Video programming can be automatically inspected during caching by the system/server to improve the video's encoding for playback and to, optionally, remove unwanted commercial advertising. Inspection might also result in indexing of the video or producing textual and/or audio transcripts. In an embodiment, the programming can be limited to viewing on the user's personal devices and cannot be redistributed.

The user may request that portions of his cached video be synchronized to his mobile devices, such that he can view it at any time he chooses, even if no Internet connection is available. Using standard encryption techniques, such synchronized video can be protected from pirating.

An embodiment includes a set of server components that work together to perform the underlying functionality, one or more client interfaces providing mechanisms for selection and viewing of video programming, and communication protocols between clients and servers.

In an embodiment, the user is be able to search or browse the expanse of multimedia content available to him from any content outlet within a single, familiar user experience. Once content of interest is identified, it may be consumed on any of the user's devices at any time. In an embodiment, in order to avoid re-distribution of such content by the user to others, the user may be restricted in his ability to pass copies of the multimedia content to other users that are unlicensed to consume it.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. Content Search

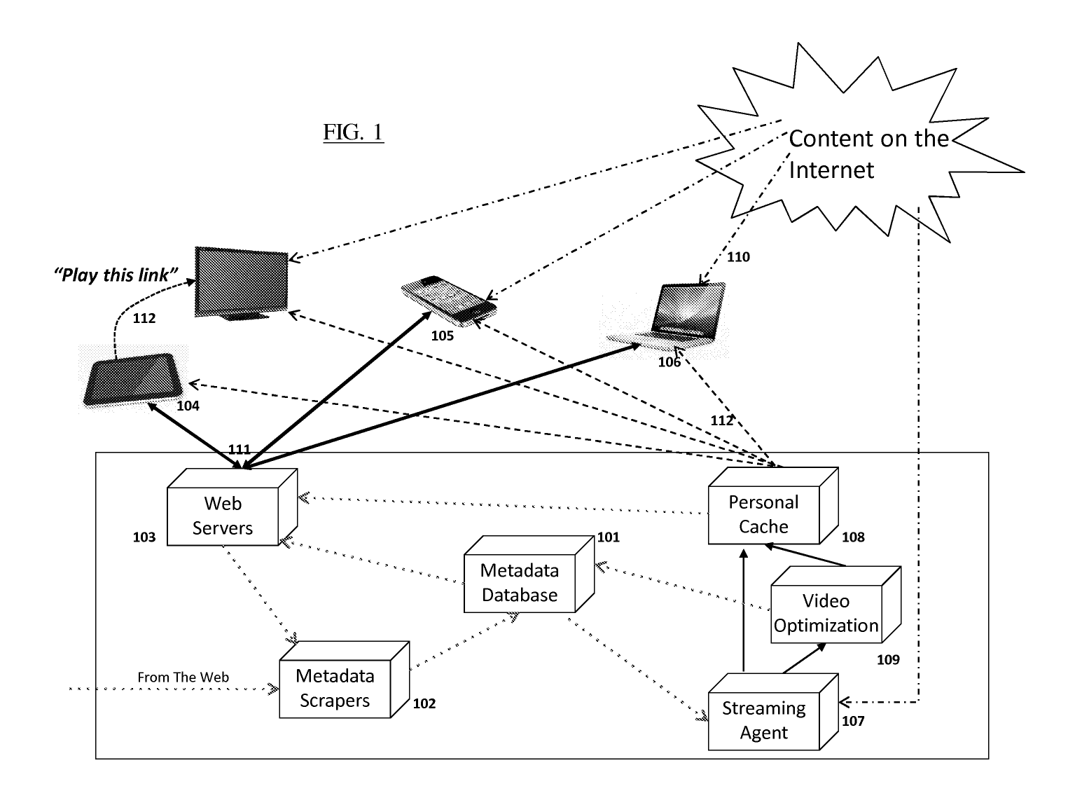

Referring to FIG. 1, a block diagram of an embodiment is shown. A central component of the system is the metadata database 101. The database may be implemented using relational or object-oriented techniques for storing, indexing, and retrieving structured information. Stored in the database are entries representing information elements within the system, e.g., entries for content available via the Internet, etc. Such an entry is called a content descriptor. Using JSON (Javascript Structured Object Notation), a typical descriptor might appear as follows:

{

”url”: ”http://www . youtube . com/watch?v=ffh63dl742”,
”title”: ”LOL Cat Video”,
”Description”: ”Watch this cat play the piano”,
”time-added”: 13456732.45367,
”metasite”: {

”name”: ”YouTube”,
”author_id”: 4523629,
”create_time”: 13456700.4536

}
”videos”: [

{

”url”: ”http://www . youtube .

com/embed?v=ffh63dl742&g=2”,

”width”: 250,
”height”: 144

}

]

}

Typical elements of such a descriptor are a URL to a Web page containing information about one or more content items, in this case videos, a title for the video, a description for it, more detailed information about the source of the content item, a playable link to the video itself, etc. Descriptors may not be unique in the database; instead, each user of the system may have stored descriptors for content of interest to them. There may be many descriptors present pointing at the same content item. However, any particular descriptor may be annotated with additional information pertinent for the user during the descriptor's existence in the system, either for the particular user or for the particular video.

The metadata database 101, although conceptually a single entity, may be implemented via multiple servers for scalability. For example, the database may be replicated across several different servers to provide high performance parallel access by many users. It may also be broken into separate components or modules across multiple servers to distribute load.

Content descriptors are created by metadata scrapers 102. A scraper is responsible for retrieving the data pointed at by a particular URL and processing it into a content descriptor. If the URL refers to a Web page, the processing might include following other links on the page in order to acquire sufficient information to create a valid content descriptor. Some Web sites might require custom actions to create a content descriptor, and these may be embodied in a separate custom scraper invoked when a particular form of URL is presented. In some embodiments, metadata scrapers may reside in one or more: Web servers, specialized metadata servers, client systems, etc.

Web servers 103 are responsible for interfacing with client devices, for example 104, 105, 106, and providing information necessary to present a useful user interface to the system on such a device (and type of device). At a minimum, the Web servers support a set of protocols 111 implemented on top of HTTP that allow retrieving information from the database 101 or storing information into it. The bulk of such operations are fetching collections of content descriptors by the client interface for presentation to the user. For clients displaying the user interface via HTML, the Web servers may also provide the HTML code and data to implement the interface. In other cases, such as an application on a cellphone 105, the interface may be generated entirely by the application, and the Web servers provide just the minimum services.

The Web servers 103 are also responsible for recording information about activity by users and client devices, such as: descriptors viewed, requests for viewing, caching content, etc. (discussed below). A user's history of activity is available for viewing by the user at any time, and, in effect is also a collection of descriptors of interest.

Streaming agents 107 and personal caches 108 implement per-user fetching of streaming video and caching of it for later playback or synchronization to a user's mobile device. A user may request such caching either explicitly, for instance by adding a content descriptor to a collection of “to be cached” descriptors, or implicitly, by indicating that some event, such as a piece of content becoming available should add a newly created descriptor for that content to the “to be cached” descriptors.

The streaming agents 107 wait for at least one descriptor to be added to “to be cached” collections, and proceed to stream the video into the user's personal cache 108. Optionally, the streams may be directed to a video optimization server 109. The video optimization server can automatically perform a number of functions to enable improvement of the video playback experience for the user. For example, it may automatically transcode the video from a less portable format such as Flash video to a more portable format such as MPEG4. It may also automatically down-scale the video for better presentation on a portable device. Part of the optimization may include recognizing unwanted segments of the video stream, such as commercials, and neglecting to cache those segments (e.g., by leaving the segment out of the stored video, etc.). The optimization server may examine the contents of the video stream to generate ancillary information, such as sequences of (e.g., relative time, byte offset) pairs that enable efficient rewind, fast forward, or other operations on the client device when the stream is viewed using protocols such as RTSP (Real-Time Streaming Protocol). “Relative time” refers to time since the beginning of the video, starting from zero.

In an embodiment, other operations performed by the video optimization server might include generation of a “thumbnail” stream, a short, low-bandwidth snippet of the stream being cached that can be used in the user interface to provide a brief indication of the contents of the video. There are many similar actions that can take place either while the stream is being cached, or at some later time on a previously stored stream. For example, generating a transcript of a video via speech-to-text processing may be performed on request by the user, perhaps for an additional fee. Processing a cached stream at a later time also permits using less expensive computing resources, as real-time processing of the stream is not required.

In an embodiment, more sophisticated operations are also possible, such as recognizing persons in the video by matching facial images to databases containing images of popular celebrities, political or historical figures, etc. Objects that appear in the video may be recognized, and their appearance indexed by relative time, for example. Speech-to-text conversion may be performed and the text stored for later reference during viewing. In all these possible embodiments, the information thus generated may be added to the user's content descriptor and stored in the metadata database 101, and thus made available to the user's client devices via the web servers 103.

In an embodiment, revenue may be generated by offering a service to users having client devices that perform the above features, thereby off-loading user client systems/devices and giving users a care-free viewing experience. Alternatively, optionally, or additionally, a service may charge a user a service or subscription fee based on the service being able to offload the user's client systems/devices.

For any particular video, any one of these possible processing steps may only need to be performed once. The first time a video is processed (e.g., by transcoding, encoding, decoding, etc.), the results can be stored in the metadata database. If the same video is to be processed for another user, then the database is checked for the results of previous processing steps on that video and, if found, those results may be used directly with no further or additional processing required.

In all of these cases, the video stream or optimized video stream(s) are delivered to the user's personal cache 108 for storage. The personal cache may be embodied in a number of different ways. For instance, the cache may be part of a larger “cloud”-based storage facility controlled by the system described herein, in which the personal cache for a particular user is of fixed size and separate from all other user's personal caches. The larger “cloud”-based storage facility may be any number of storage facilities/devices available in the cloud and used by the system. Users may be charged a fee by the system or accounting server for the amount of cache storage space the user reserves, uses during a period of time, uses beyond a reserved amount, etc. Alternatively, optionally, or additionally, the personal cache may be supplied, possibly all or in part, by the user of the system in some fashion. For example, it may be held in storage owned and controlled by the user that is accessible via the Internet, such as a disk drive at the user's home, in “cloud”-based storage obtained by the user, etc. Alternatively, optionally, or additionally, the user's personal cache may be stored in any combination of system supplied and user supplied storage devices/facilities.

The personal cache is responsible for implementing storage policy. For instance, a user may request that more video be cached than there is currently space for in the personal cache. In such a case, either currently cached video has to be deleted to make room, additional room purchased, the new request for caching denied, etc. These policy settings may be controlled by the user or the system. Once a particular video has been cached, the user's content descriptor for that video is updated to reflect its caching.

In an embodiment, when the user is using the client interface to the system, for instance a Web page running on a PC 106, the client software fetches portions of the user's collection of content descriptors and presents them in a useful manner. If the user selects a descriptor and indicates he wishes to watch the video, the client interface checks the descriptor to see if the video has been cached or is present in local storage (discussed below). If so, the client interface may contact the personal cache 108 to request streaming of the video. If some form of video optimization has been performed, that data may also be available in the content descriptor, allowing use of the data to enhance the user's viewing experience in various ways.

In an embodiment, if the descriptor for a particular video indicates that it has not been cached, then a direct URL included in the descriptor can be used to directly play back the video from its source 110; this may result in less than optimal playback for the user. Alternatively, optionally, or additionally, if the descriptor indicates that the video is cacheable, the user may indicate that it should be cached for later viewing instead. The client interface informs the web servers 103 of this request, where the descriptor is added to the user's collection of “to be cached” videos.

A user may be at home using a mobile device to peruse content descriptors that have been saved for him. He may have a network connected television of some kind, or an intermediate device that can display content from a network source on the television. The user may indicate to the client interface that a particular video be played back on the television, and the client interface 112 directs the television or intermediate device to fetch and play back a video stream, e.g., an optimized one from the user's personal cache, directly from the source, from another device, etc. Such actions may take place between any of the user's network-connected devices.

In an embodiment, the client interface may also support synchronization between the user's personal cache 108 and local storage on the device; in general this involves simply storing video fetched from the personal cache into local memory rather than displaying it. The client interface may implement a policy indicating how the local storage should be managed, for example, which videos should be synchronized, or what replacement and update policies should be followed. If the client device supports some form of encryption for synchronized content, then the client interface may direct that this occur.

Communications between client devices and the user's personal cache 112 may be secured, if so desired, in a number of different ways. The use of SSL (Secure Sockets Layer) is one standards-based method for doing so. In order to ensure that only the user accesses content in his personal cache, it may be necessary for the user to authorize a particular device or devices. One way in which to do this is for the client interface to initiate authorization with the personal cache 108, whence the personal cache (e.g., the personal cache server, cache managing server, etc.) generates a signed “cookie” that the client interface saves on the device in some secure fashion. Thereafter, in order to access his personal cache, the user's device must present this signed cookie to the personal cache to validate its identity. The user is free to de-authorize a device at any time.

### 3. Content Descriptor Creation and Management

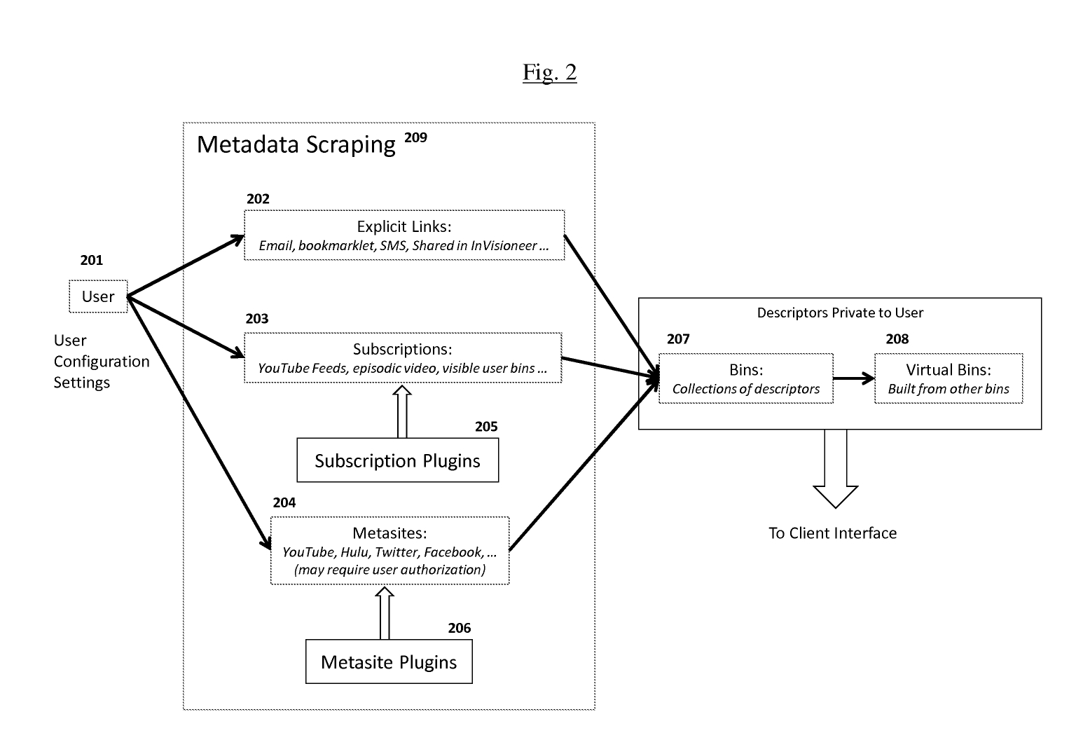

Referring to FIG. 2, in an embodiment, the system involves the creation and management of content descriptors. A metadata scraper 102 is composed of a number of generic and specialized modules for processing URLs into content descriptors. In an embodiment, there are at least three ways in which URLs are discovered by the metadata scraping process 209:
1. By explicit reference 202. For example, enclosed in an email message, via a custom browser button (e.g., a bookmarklet), a text message, or perhaps just direct entry.
2. Via a subscription 203. For example, via periodic checking of a standard feed via RSS, or polling a particular website to see if new episodes of some episodic content have arrived, or by examining collections of descriptors added by other users (see below).
3. Via a metasite 204. A metasite is another web service that provides metadata about content that may be of potential interest to a user. A metasite typically requires user authorization for access to collect this information.

Metasites typically have social networking features of various kinds. As an example, consider Facebook. Users may post comments, photos, videos or links to video, and other users may provide feedback or their own posts. It may be the case that recommendations about content from people that a user considers his friends are valuable to the user. In such cases the system described herein may automatically poll the user's timeline on Facebook, recognize new content links, and automatically generate content descriptors for them. Perhaps the user even wants such content to be automatically cached in his personal cache for optimized or synchronized viewing, in which case the new content descriptor is forwarded to the caching dispatcher (discussed below).

As another example, consider YouTube, where a user may mark a video as a “Favorite”. The system described herein may automatically notice when a user has marked a video as such, and trigger automatic descriptor creation.

For both subscriptions and metasites, it is typically the case that the original website has aspects that must be addressed in a custom fashion. For example, the ways in which the Facebook timeline are accessed are very different than those for YouTube. In an embodiment, a mapping from the subscription site or metasite to content descriptors is created by the system in order to access these entities using a standard content descriptor; these mappings are created via custom plugins 205, 206.

In an embodiment, during scraping, the specific scraping module may attempt to identify the actual source URL for video identified via the metadata obtained from the original URL. For example, a source URL for the video may be embedded into the Web page at the original URL via a standard mechanism, such as the Schema.Org or OEmbed embedding standards. Alternatively, a particular website may use a custom embedding technique which must be decoded. If the source URL for the video can be discovered, it is added to the new descriptor.

Once descriptors are generated, they may be organized and collected into useful groupings for the user. These groupings are called bins 207. For example, all descriptors generated from scanning a user's Facebook timeline might be stored in a single bin called “Facebook”. The user might have another bin called “Shared” which contains descriptors passed on by other users, potentially with commentary. The user may choose to create his own set of bins, assembled from descriptors that concern similar types of content.

It may be the case that content descriptors should be presented in a very different fashion, perhaps computed on demand for the user. For example, the user may wish to see the most recently generated descriptors across all his bins. Thus, he may view a virtual bin 208 that is constructed on request showing these most recent entries, and the actual bins from which each descriptor was fetched. The system described herein can support any number of different virtual bins, assembled on demand according to various algorithms.

In an embodiment, the entirety of information needed to properly generate the descriptors the user desires, manually or automatically, the bins and virtual bins that he wishes to create, populate and view, and settings for managing his personal cache and the caching of video are stored privately for each user in the user configuration settings 201, which are stored in the metadata database 101.

### 4. Video Caching to the Personal Cache

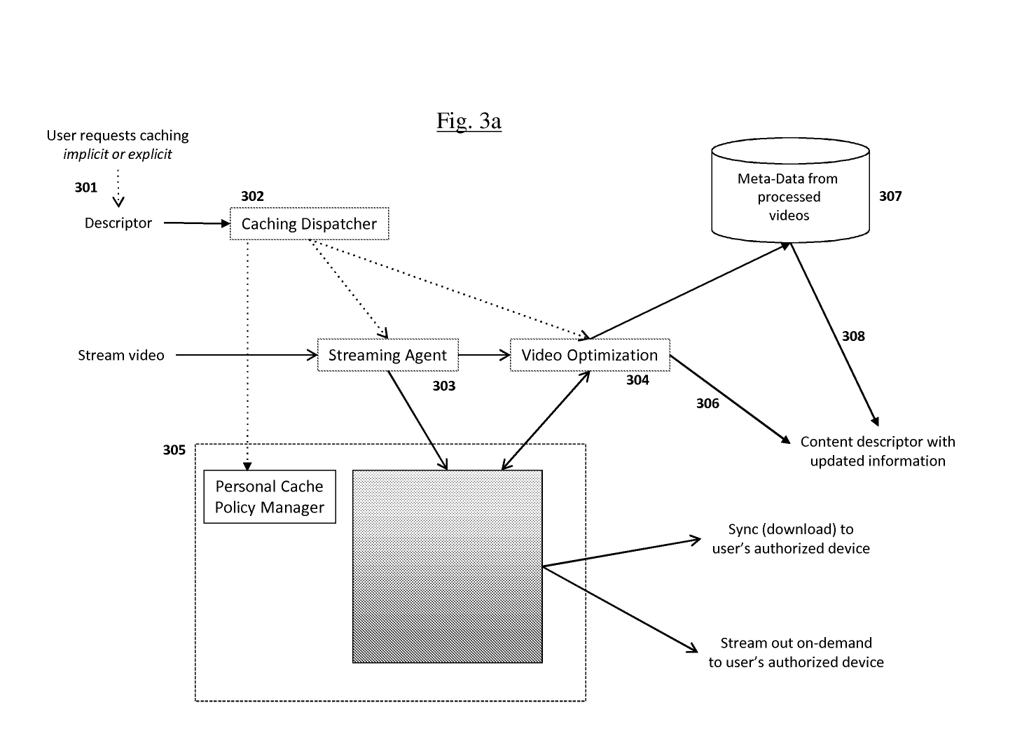

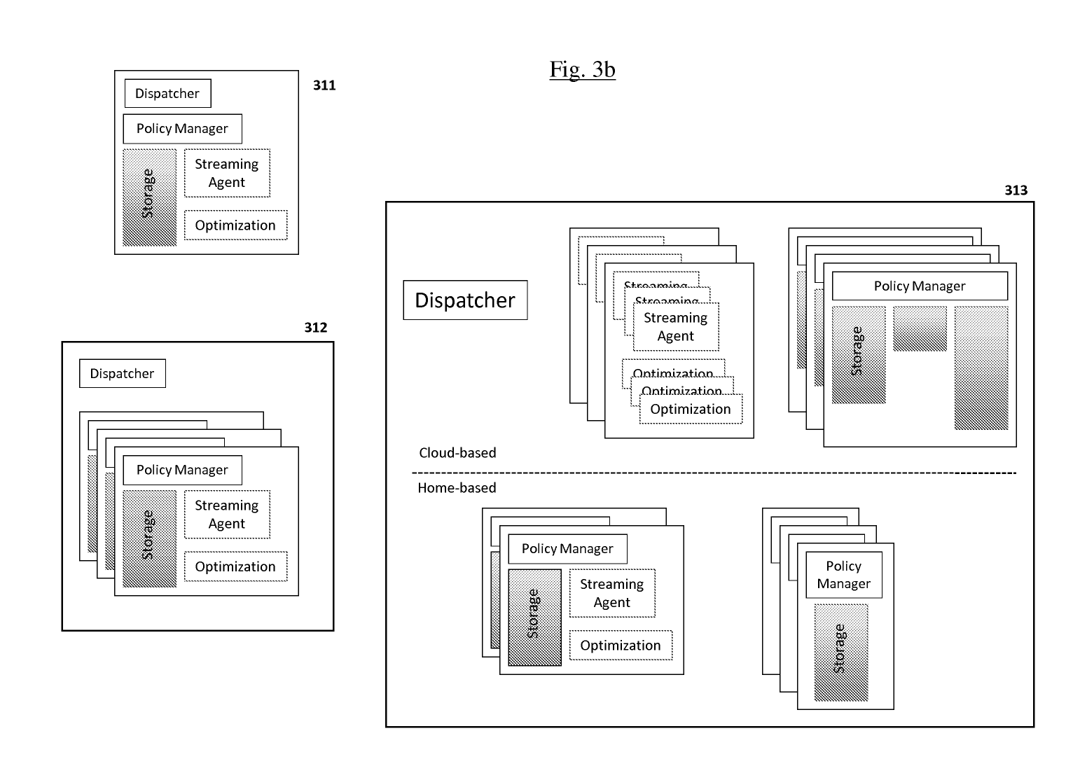

FIG. 3 shows a schematic overview of the video cache. In an embodiment, caching begins when the user, either by direct request, or via a configuration setting 201 requests caching of a particular descriptor 301. The descriptor may be forwarded to the caching dispatcher 302. The dispatcher may direct a streaming agent 303 to begin processing the associated video. The streaming agent may be directed to pass the video to an optimization step 304 or directly into the user's personal cache 305. At some later time, the video may be fetched from the personal cache for viewing or synchronization to a user's client device.

Referring to FIG. 3a, in an embodiment, the simplest configuration of this process is for a single user (note that this process can easily be expanded to multiple users), whereby the dispatcher 302, streaming agent 303, optimization 304 and policy manager 305 are combined into a single entity managing a single pool of cache storage 311; such a configuration might run on a dedicated server or PC in the user's home or may be distributed among multiple devices.

In an embodiment, another configuration is shown in 312. Here the streaming agent, optimization and storage are combined into a single unit, perhaps on a single PC, and there are multiple such units. For instance, each unit might run on a PC in a user's home, and the dispatcher runs on a central server. The dispatcher sends content descriptors to each individual user's processing and storage unit for processing. The individual units might instead each be a user dedicated processing and storage unit in the “cloud”, each unit being rented out to that user on a monthly basis, e.g., by a service, provider, etc.

In an embodiment, a much more complex configuration is shown in 313. Here, most of the streaming agents and optimization servers are separate from the cache storage. These servers and the cache storage for many users are located in the “cloud”. Residing in the user's home, a personal cache may be standalone, or include streaming and optimization functions. It is apparent that embodiments allow many different configurations of the dispatching, streaming, optimization, policy and storage units to achieve the best operational efficiency for a particular user model.

In complex configurations such as 312 and 313, the role of the dispatcher can be quite complex, as it implements policies with multiple aims.

For example, caching requests may be queued and dispatched in such a manner to optimally use scarce streaming and video optimization server capacity. In some cases, where server capacity may be dynamically added or removed, for example, when using Amazon Web Services, the caching dispatcher may recognize that queue lengths are becoming too long, and can bring additional server capacity from a pool of servers on-line. Alternatively, it may recognize that servers are sitting idle for long periods and can release those idle servers.

In an embodiment, the dispatcher may also implement user-oriented policies. For example, the service may provide several tiers of caching performance to the user, and the user may wish to pay more or less to get a video cached sooner or later. Users that have paid for a higher tier of service may have their descriptors moved ahead of those for users that are on lower service tiers. In another example, if a particular user queues too many descriptors, descriptors from other users may be selected first for processing to provide fair access to caching among all users.

The dispatcher interacts with the policy manager for a personal cache to determine the availability of storage for a stream. If the personal cache is nearly full, the policy manager may decide if video currently in the cache is to be deleted to make way for the new video, reject processing of the video, ask the user if he wants to purchase additional storage, etc. Another possible policy is to automatically allocate additional storage if available, perhaps at some additional cost. If a user provides home-based streaming and optimization functions along with the personal cache, the dispatcher may simply relay the content descriptor to that unit for processing.

Eventually a descriptor can be chosen for processing and forwarded to the streaming agent. If video optimization is desirable, the dispatcher can also allocate optimization resources at the same time. In some cases, the streaming agent may perform the video optimization, in others the streaming agent and the video optimizer may be separate processes on a single server, or even reside on separate servers. In any case, the video stream from the source site passes through the streaming agent and optional video optimization, and may be written to the user's personal cache as an ongoing stream until the stream has ended. At that point the streaming agent may update the content descriptor to indicate that the video has been cached, and may add data resulting from video optimization 306. After this a client device may access the video and stream to an authorized device. The client device may initiate synchronization to local storage for the user.

The video optimization step can track which videos have had the operations described above performed on them in a meta-data database 307. Even though different versions of the same video may have been cached for different users, the processing for optimization may recognize that a previously processed video is being handled. For example, the title and description of the video in the content descriptor might match. In another example, even though YouTube assigns a single video ID to unique videos, there may be different versions available, such as a high resolution version encoded using MPEG4 and lower-resolution versions encoded with Flash Video. In such cases, the content descriptor information may include the YouTube video ID, and this can be used to look up previously stored information about the video. If previous processing has resulted in interesting meta-data about the video being stored, then there is no reason to perform that same processing again. Instead, the meta-data is simply added to the content descriptor and stored for the user 308.

### 5. Streaming Agent

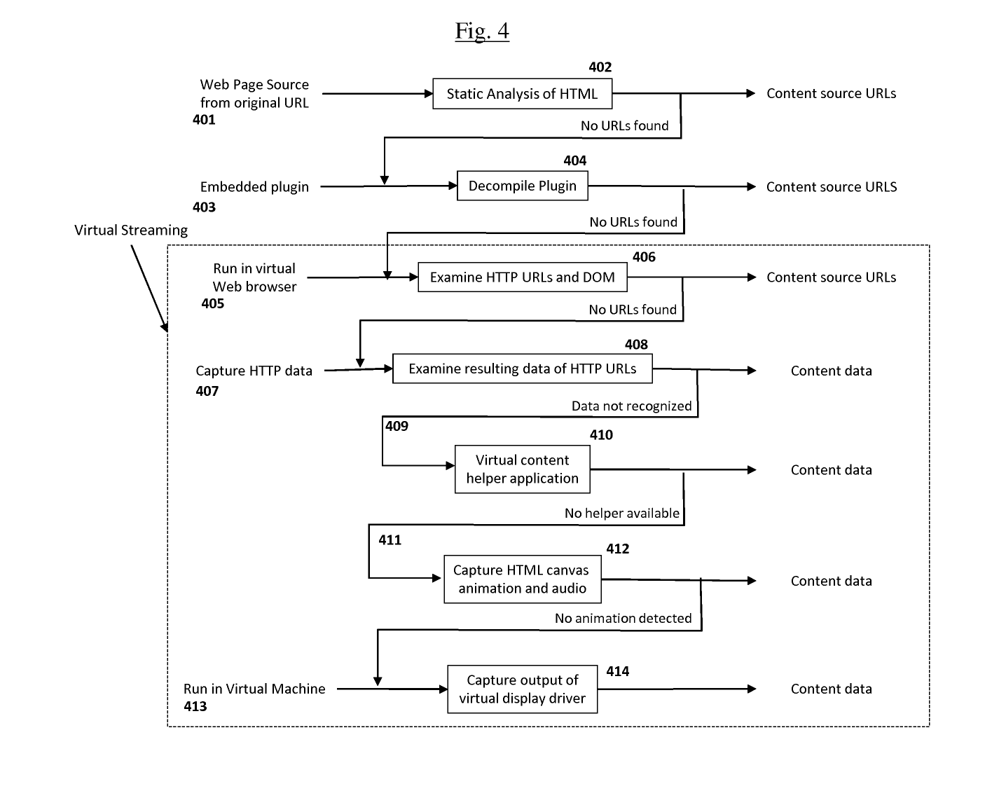

Referring to FIG. 4, in an embodiment, operation of the streaming agent may be: given an original URL to some source of video, it finds and streams the video stream into the system and passes it on for optimization and/or caching. Although the streaming agent has been presented in the context of video caching, it may also play a role in streaming optimized video directly from a Web site if the video has not been previously cached for the user. The details of the actions of the streaming agent described here apply to this case as well if the client device has sufficient hardware resources to perform these actions. In fact, this is increasingly the case, as the computational power needed is present in most smartphones and tablets today, and increases over time.

Video streams may be presented in many different ways. Sometimes the URL points directly to a video source file that may be simply fetched via an HTTP GET. More often the URL points to a Web page which embeds a URL for the video stream 401. Using simple static analysis of the HTML it is possible to extract the video stream URL 402.

Sometimes the URL will indicate a more complex playback method, such as via an embedded Adobe Flash streaming plugin 403. In such cases, the streaming agent needs to use more sophisticated techniques to acquire the actual video stream.

In an embodiment, the agent may de-compile the plugin and search its resources for the video source URL to use 404. In an embodiment, the video may be retrieved piece-by-piece using certain techniques, such as Apple's HTTP “Live” streaming or Adobe's F4F format, in which a manifest file is first downloaded by the plugin, the manifest indicating URLs for short segments of the video and the order in which they should be played. In such a case, the streaming agent attempts to recover the manifest, and then streams the segments itself as a continuous video.

In an embodiment, if these steps fail, the streaming agent may adopt more aggressive approaches. These are generally termed herein as virtual streaming. In virtual streaming, the streaming agent actually runs the streaming plugin within an environment that appears as a browser to the plugin 405. One technique for implementing virtual streaming is to take a popular open-source browser, such as Google Chrome, and modify the code to add appropriate hooks for access and control of the browser environment, and remove most of the actual drawing and output code.

In an example of virtual streaming, the streaming agent monitors HTTP requests by the plugin, from which it may be able to determine the source URL as it is requested by the plugin 406. Alternatively, the streaming agent can examine the internal environment of the running plugin by examining the DOM (Document Object Model) within which a streaming plugin is running, monitoring modifications and browser control requests for clues to obtaining the video data.

Since the streaming agent is able to examine the actual data flowing inside most requests and responses 407, it may be able to identify the actual video data as it is delivered to the plugin, and direct that data for optimization and/or caching 408.

It may be the case that the video data is encrypted in some fashion that only the plugin knows how to decrypt 409. In such cases, when and if the plugin requests the invocation of a content-specific handler for the video, the streaming agent can provide an interface to the plugin that appears to be that content-specific handler, and thus obtain the video data for optimization and/or caching after decryption by the plugin 410.

In an embodiment, in some cases, the plugin may decode the video data itself and directly draw it onto an HTML “canvas” 411. In parallel, the plugin directs an audio stream to be decoded by a helper application. The streaming agent captures the audio stream. When the plugin detects the beginning of a new animation cycle in the plugin, typically through a browser call by the plugin, it copies the newly drawn frame out of the canvas before allowing the plugin to draw the next frame. It thus obtains the full video along with the audio, which it packages and presents for optimization 412; in this case, part of optimization is encoding the video into a compressed digital format such as MPEG4.

In an embodiment, in some cases, the streaming agent may adopt an extremely aggressive approach. For example, certain operating systems such as Windows incorporate low-level subsystems which combine decryption and decoding of video streams provided in proprietary formats. In these cases, it becomes necessary to run the entire operating system within a virtual machine 413. The video and audio drivers provided to the virtual machine are processes that take the video and audio bytes as they are written into memory by the operating system and pass them through to the streaming agent 414, which forwards the data on as described previously.

### 6. ATSC Broadcast Content Transfer to the Streaming Agent

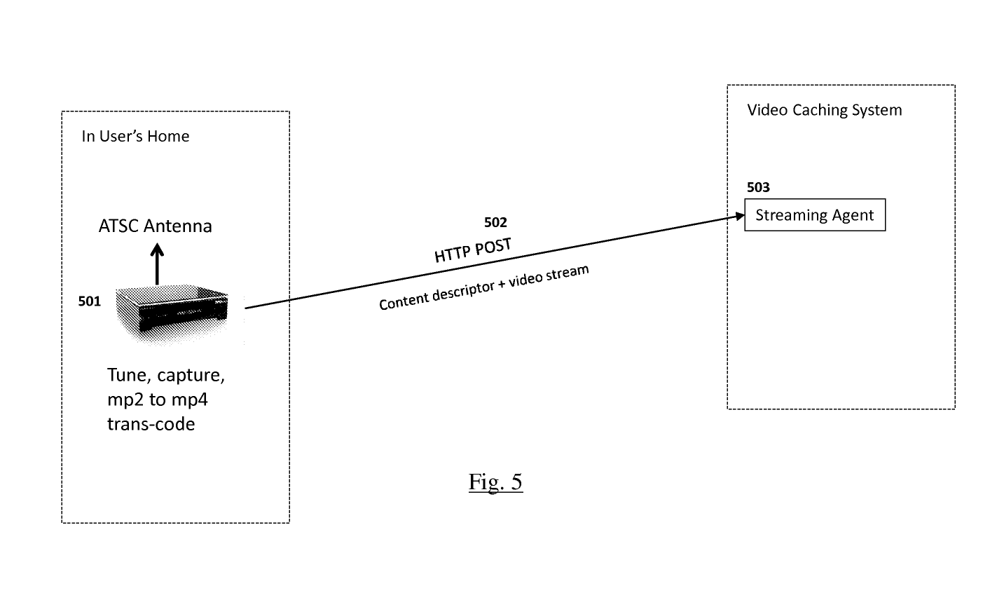

Referring to FIG. 5, in an embodiment, a small ATSC receiver 501 may be placed in an optimal position for reception in a user's home. This receiver also incorporates hardware and/or software providing transcoding of MPEG2 broadcast content into MPEG4, thus greatly reducing the bandwidth of the video stream. The receiver also supports a Web client configured to communicate with a streaming agent 303 at a video cache as in FIG. 3. Also configured into the receiver is a time-based schedule specifying channels and time-frames when content of interest is to be broadcast.

According to the schedule, when content of interest is broadcast, the receiver tunes to the proper channel and captures the broadcast MPEG2 stream, which it transcodes into MPEG4 format. As this process begins, the receiver connects via an Internet connection to a streaming agent 503. It first sends a content descriptor, followed by the content itself. The receiver continues sending streaming content until the schedule indicates that streaming should conclude.

The streaming agent may either directly store the content in the user's personal cache, or first arrange for possible optimization steps.

### 7. Handling Personal Multimedia Content

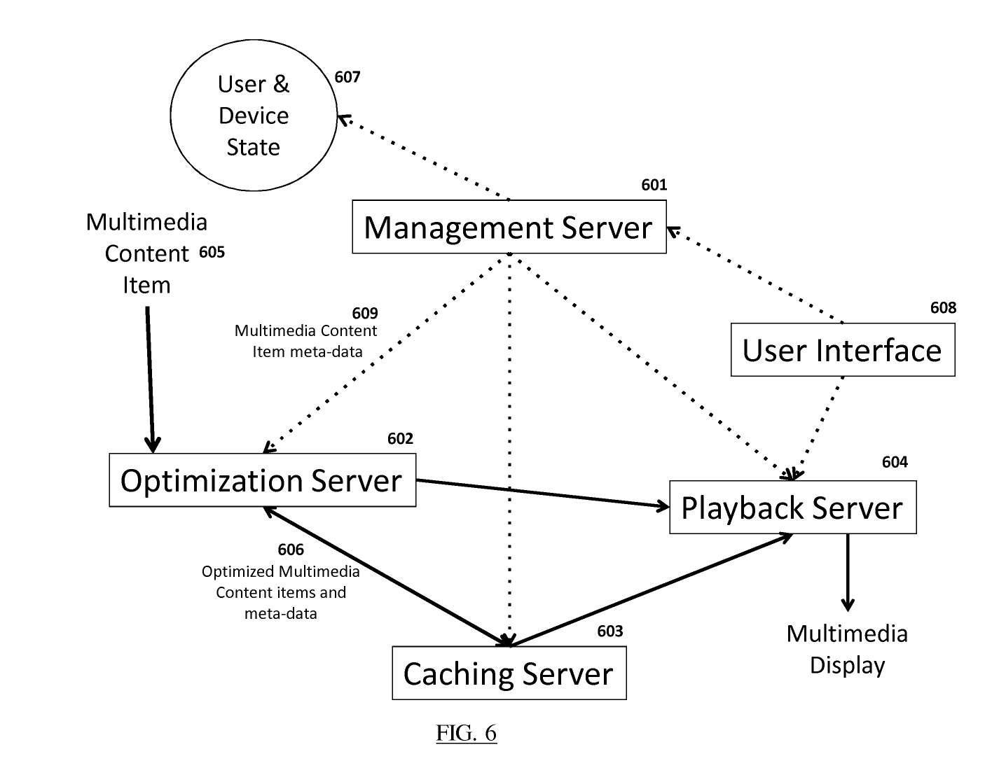

Referring to FIG. 6, an embodiment may be comprised of five main components. These components work together to obtain, process, cache, and display multimedia content items on behalf of a user. A multimedia content item 605 may be any digital entity composed of one or more video and/or audio streams intended for presentation to a user.

A management server 601 stores information about multimedia content items, called metadata 609, and is responsible for coordination of service activities to provide the desired user experience. The management server provides metadata to the other components, and directs and manages their operation as appropriate.

Multimedia content item metadata typically includes information such as any combination of: title, description, running time, media type, playback URL, actor names, creation date, etc. The playback URL usually indicates a location on the Internet whence the actual multimedia content item may be downloaded or streamed.

An optimization server 602 is responsible for processing a multimedia content item into one or more optimized multimedia content items 606 suitable for specialized manipulation and display within the system. A management server directs this work by passing multimedia content item metadata to the optimization server. The optimization step may do nothing if the multimedia content item is already properly optimized; an optimized multimedia content item is also a multimedia content item.

In an embodiment, optimization may involve a number of steps. The first of these may be automatic acquisition of the actual multimedia content item, which may be followed by transcoding of the content item from one format to another, as discussed above.

An optimization server forwards multimedia content items and metadata to various Caching or playback servers as directed by the management server. An optimization server may provide periodic status indications to a management server, such as progress on optimizing a particular item.

In an embodiment, a caching server 603 stores multimedia content items and metadata for later use. Under direction of a management server or user interface multimedia content items and metadata may be forwarded to other caching servers, to an optimization server for additional processing, or deleted from the caching server. Upon request by a management server or user interface, a caching server may forward multimedia content items to a playback server or a playback server may directly request forwarding of a multimedia content item from a caching server. A caching server may provide periodic status indications to a management server or user interface, such as the amount of content stored and metadata of stored items.

In an embodiment, a playback server 604 presents multimedia content items to a user for viewing or audio playback. It may obtain these items from a caching server, optimization server, or access them from an external location if appropriate. During presentation, the playback server may provide status information to a user interface, such as the current state (e.g., playing, paused, fast-forwarding, etc.) and playback position (e.g., at time 5:32). The user interface may direct the playback server to start or stop playback, to change playback state, to move to a particular position, or take other appropriate actions.

In an embodiment, a playback server may maintain a queue of multimedia content items to be played back in sequence. For example, the user may indicate a sequence of items to be played back, each one being added to the queue. The playback server can continue to play items in the queue in sequence independently of other activities in the system.

In an embodiment, the user interface 608 provides a mechanism for the user to request metadata or operations from any combination of: management, caching, and optimization servers, and/or directing a playback server for viewing and playback of multimedia content items as described above.

Each of the described components provides an Application Programming Interface (API) through which a component may be queried and controlled. In an embodiment, the component provides the API via HTTP POST requests returning JSON-formatted data. In another embodiment, the component may provide the API via direct method calls, for example, if the communicating components reside on a single computer system. In any case, the same functionality may be presented through the API regardless of how it is provided.

In an embodiment, optimized multimedia content items are kept in HTTP Live Streaming (HLS) format. This format splits the multimedia content item up into a number of short segments, the segments being described in a separate manifest file. Using this format, the content may be easily transferred between devices either for download or streaming

Although these components are described separately for clarity, they may be implemented within a single computer system or arbitrarily distributed among many interconnected or periodically interconnected computing systems.

### 7.1 User Devices

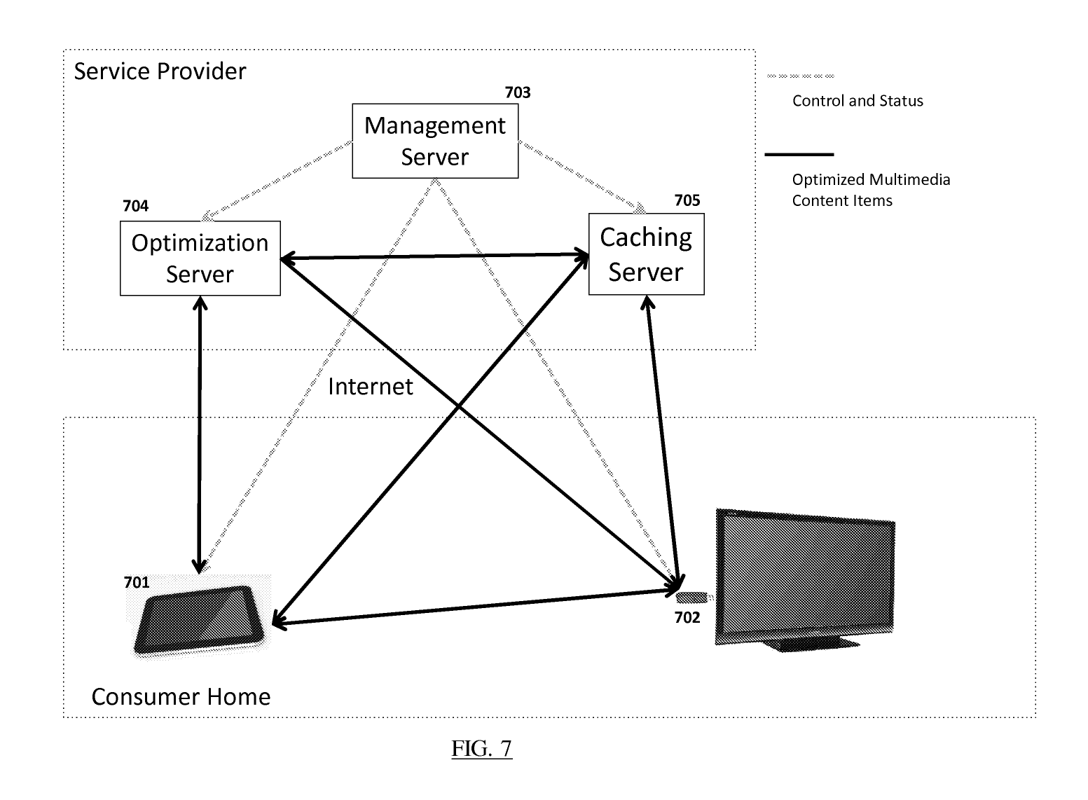

FIG. 7 illustrates an example embodiment to assist in discussing features of the system. This embodiment is described in order to provide additional clarity concerning operations of the system.

In an embodiment, a user device 701 provides the user interface, and may also provide an optimization server, caching server, and playback server. For example, 701 may be a touch-screen tablet, e.g., an Apple iPad, Android tablet, Windows tablet, etc., capable of performing all or some of these functions.

Optionally, the user may possess an Experience Delivery Device (EDD) 702 providing at least a playback server, and which may also provide an optimization server and/or caching server. One purpose of the EDD is to allow remote controlled playback of multimedia content items through a large viewing system, such as a television or home theater system. In an embodiment, the EDD may include a wireless network interface, e.g., based on the IEEE 802.11n standard, 802.11x, etc., and an HDMI output interface for delivery of video and audio signals for display.

In an embodiment, the functionality of the EDD may be incorporated into the display system, for example, as an application on a network-connected television or set-top device. In another embodiment, the functionality of the EDD may be incorporated into an external device, such as a cable set-top box or game console.

In other embodiments, there may be multiple user devices and multiple EDDs in the system.

In an embodiment, a service provider may have a management server 703 storing metadata about multimedia content items and information about the user of the system and the plurality of his registered devices 701, 702. The service provider may also provide a plurality of optimization servers and caching servers. All of these components may communicate with each other using various digital networking technologies, e.g., Internet protocols, etc.

### 7.2 Functions Implemented Within a User Device

In an embodiment, the user device 701 may be any suitable device capable of supporting a user interface. It may also provide a playback server; if sufficient local storage is available, it may provide a caching server; if sufficient processing power and memory is available, it may provide an optimization server. The user interface may be implemented via a downloaded application or via a Web application implemented using standards, e.g., HTML, HTML5, Java, etc.

In an embodiment, the user interface contained within user device 701 can communicate with the management server 703 for at least any combination of the following functions:
1. Access to metadata about multimedia content items, e.g., title, description, display image, format, size, etc.;
2. Access to similar metadata about optimized multimedia content items, further including information indicating the caching or optimization servers from which those items are available;
3. Requests to move, transfer, or delete multimedia content items among available caching servers, including one possibly contained in user device 701;
4. Requests to optimize multimedia content items and forward the optimized items to a caching or playback server, which may include one possibly contained in user device 701; or
5. Download and install updates to service specific software and data stored on the user device 701.

The user interface in user device 701 communicates with a playback server to initiate playback of multimedia content items. The playback server may be contained within user device 701 or within some other device, for instance EDD 702. The user interface can direct the playback server to obtain multimedia content items from a caching server. This may be a service provider caching server 705, or perhaps caching servers contained in 701 or 702.

### 7.3 Functions Implemented Within the Experience Delivery Device (EDD)

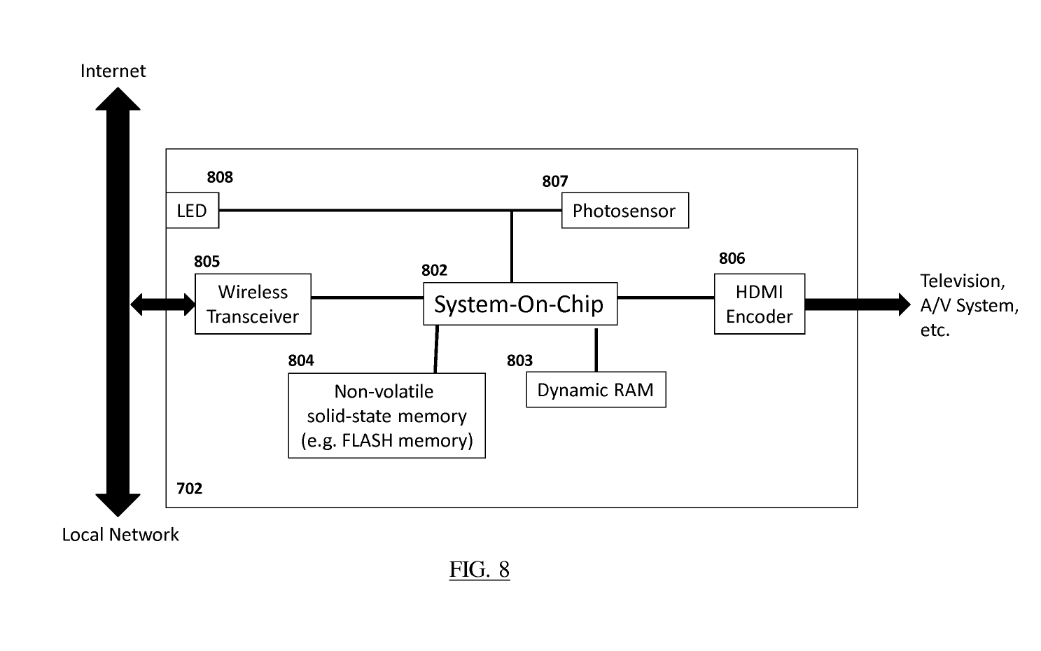

FIG. 8 illustrates an example embodiment of the EDD 702. In an embodiment, a system-on-chip 802 can be the core component, and can provide a high-performance CPU, a real-time MPEG encoder and decoder, 3D computer graphics acceleration, or other components as necessary for a functioning system. A large amount of DRAM 803 can be included to support the encoding, decoding, and graphics functions. A large amount of non-volatile storage can be included 804, providing space for operational software and multimedia content caching.

Embodiments of the EDD may include one or more of: an optimization server, a caching server, or a playback server.

In an embodiment, a wireless transceiver 805 supports network communications for control and status requests, and transfer of multimedia content items. An HDMI encoder 806 can accept display signals generated by the system-on-chip 802 and can output an HDMI signal suitable for display on a television or routing through an A/V system or HDMI router.

In an embodiment where the playback server maintains a queue of items to be played, the playback server may first render a short display containing the title of the item, and other interesting metadata that may be available.

In an embodiment, if a caching server accessible to the playback server has newly cached a video, the playback server may display an indication of the arrival. For example, the indication may be via an overlay of a message on some part of the screen for a short period, or perhaps playback of a particular tone indicating a new item is available. The user might then pick up their device 701 to find out if the new item is interesting for immediate playback or adding to the playback server queue.

If the EDD is not currently playing a multimedia content item, it may optionally generate an arbitrary multimedia content stream for display on the attached HDMI device. Example content streams might be a sequence of images, a 3D rendered sequence, cached multimedia items, and so forth. In an embodiment, the EDD renders tips on using the system. For example, how to add items to the queue in a playback server via the user interface.

### 7.3.1 Playback of a Single Video

In an embodiment, a user may indicate a video to be played on the user device 701. The URL (and/or other identification information) associated with the video is sent to the EDD 702 from the user device 702. The EDD 702 accesses the URL to stream or download in order to play the video.

Playing the video involves opening an HTTP connection to fetch the content at the other end. If the mime type indicates a video, then the stream can be directly played, and it is passed to the video player.

If the mime type indicates a Web page (e.g., HTML), then the EDD 702 can load the page and examines the HTML. Often, the HTML will include links to the actual video, which is then fetched and played as above. For example, YouTube encodes pointers to video files for multiple formats and resolutions in an obsfuscated format.

In an embodiment, the EDD 702 can pattern match on the URL itself. For example, if the pattern matching indicates that the URL is YouTube, then the URL can be passed to a YouTube URL extractor. If the pattern matching indicates that the URL is Vimeo, then the URL can be passed to a Vimeo URL extractor. The URLs to the actual media streams are then constructed based on various data and string values pulled from elements within the HTML. For Vimeo, the media URLs are not explicitly included in the HTML. For Youtube, multiple URLs can be found, and the extractor can parse the metadata for each stream to choose the appropriate variant based on format, video/audio codecs, resolution, stereo 3D, etc.

If no link is encoded in the page, it is often the case that an “embed”—a chunk of HTML that downloads a video player (often written in Adobe Flash format) and plays the video. In such cases the EDD 702 may load a Web browser, passing the embed to it, and indicating that it should use full-screen playback, making the browser transparent to the viewer. The software on the EDD 702 may look into the DOM (Document Object Model) graph kept by the Web browser to ascertain where playback controls (e.g., “play”, “pause”, “skip”, etc.) are located, and direct specific events to those controls to control the playback on behalf of the user.

In other cases, the URL passed to the EDD 702 may indicate a proprietary player. For example, the URL may indicate a video from Netflix. If, for example, the EDD 702 is implemented on an Android-based device, then the EDD software may load the Netflix video player, and pass it the URL.

In cases where the EDD loads an external program to play back the video, one option for controlling the external program is to interceed in the input and output paths of the program to detect its state, and to pass events, for example, remote control key presses. In some cases it may be useful to capture metadata about the external program's activity in order to discern its state. For example, the EDD software may examine the stream of operating system calls that the external program makes, searching for calls to open, read or write device files, load dynamic libraries, etc.

Widely used operating system virtualization technologies can be used to load the external program into a “virtual machine”. Examples of virtual machine technologies range from the commercial, e.g., VMWare, etc., to the open source, e.g., VirtualBox, etc., to para-virtualization technologies embedded in the Linux operating system, e.g., Xen, etc. This allows the EDD software to monitor and control all potential communication paths in order to discern and control the state of the external program.

In some cases, if the video framebuffer is accessible to software running on the EDD 702, the framebuffer can be examined to discern the state of the external program, in order to discern what event to pass to the external program next.

### 7.3.2 Playback Control and Reporting

In an embodiment, an external control plane (e.g., a user device 701, another EDD, etc.) may pass viewer directions to the EDD 702, e.g., to pause the video playback, to skip forward a few seconds, etc. This can be done as a separate HTTP transaction, or the control plane may hold a connection open with the EDD 702 and simply pass events over the connection as needed.

The EDD 702 may report the current playback state back to the control plane. If the control plane and EDD 702 maintain an open connection, then the EDD 702 may periodically send a status event to the control plane, which may update a display (e.g., on a user tablet, etc.) to indicate playback progress through the video. Alternatively, the control plane may pass a URL for itself along with the video, and the EDD 702 can periodically send an HTTP request to that URL indicating the current playback state.

When a URL is sent to the EDD 702 for playback, the control plane may also include another URL used to report playback state to a central service. This allows the service to record the fact that a video has been played, as well as allowing the service to maintain a record of current playback position. This is useful in allowing the viewer to stop viewing the video, and later starting viewing again from the same position. It also allows the viewer to query the videos he has played in the past, for instance, to show a friend something he found interesting. One of the additional features of reporting playback position to a central service is that what the user most recently watched can be made accessible across all of the user's enabled devices. This allows a user the ability to stop playback on the EDD 702, for example, and pick up at the same playback position on a tablet, or vice versa.

Such viewing data has analytical value when examined in the aggregate, e.g., to determine what videos are most popular, where viewing was abandoned, etc.

The URL used to report playback status to a central service may be specially coded to ensure that the reporting is directed to a specific user account. It may be further encoded with a timestamp to make the URL valid only for a short time frame. These features are necessary to prevent an invalid status being reported, e.g., “spam”. The control plane, which has been authenticated to the central service, is responsible for obtaining this special URL from the service and passing it to the EDD 702, obviating the need for the EDD 702 to be associated with a specific account.

### 7.3.3 Multi-Video Playback

In an embodiment, the EDD 702 may implement a playback queue. In normal operation, the EDD software takes the first entry from this queue and plays it back as described above. Once the current video is complete, the EDD software takes the next video from the queue and plays it, and so forth until the queue is empty.

The control plane, at user direction or automatically (e.g., triggered by an event, triggered by a posting on a social networking website, etc.), may add a new video URL to the queue at any time via either an HTTP request to the EDD 702 or over a permanent connection between the EDD 702 and the control plane.

The control plane may also perform other manipulations of the playback queue. For example, it may cause multiple videos to be queued at once. It may instead request that a video be placed first in the queue before all of the other queue contents. It may request that the currently playing video be stopped and the next video in the queue be played. It may request that the queue be flushed. It may reorder existing items in the queue.

The playback queues enables the user to request playback of any number of videos in sequence. The user may then close the control plane, e.g., turn off the tablet, while the videos he queued continue to play back unperturbed. Although video content is mentioned herein in the examples, the embodiments described herein may also apply to other multimedia content including, but not limited to, any combination of: image files, text files, object files, etc.

### 7.3.4 EDDS and Social Networking

In an embodiment, the EDD 702 may accept playback and queuing requests from multiple control planes at once. This enables social interaction and games among the viewers of the video, for example, viewers queueing video to playback on a single EDD in response to another viewer's selection of a video (e.g., a video party, a video marathon, a video showdown, etc.).

In an embodiment, multiple users may submit media to a common EDD. Each user may have the ability to pass (e.g., “next” or “veto”) a video that is currently playing on the EDD. In an embodiment, users accrue points based on how long their videos played on the EDD before another user overrode their video. This is just an extreme gamification model, but more interesting interactions could be designed for a highly social interactive media experience with a group.

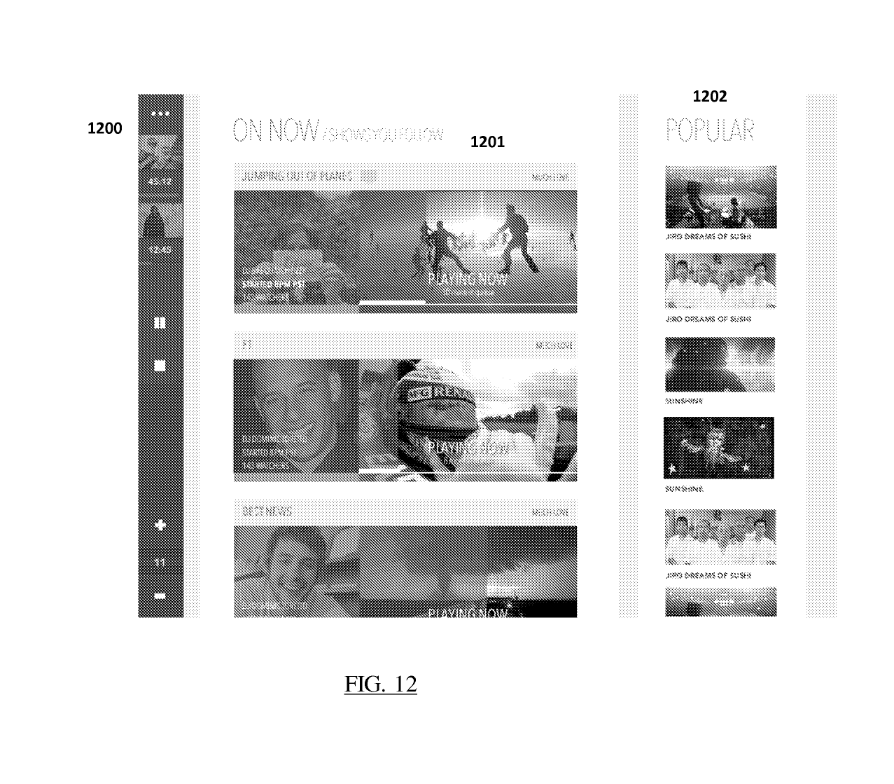

Referring to FIG. 12, a user interface screen 1200 is shown that may be displayed on a user device 701. The management server 703 may store information pertaining to the: videos a user views, videos the user caches, videos or other users the user selects as favorites, other users or channels the user follows, etc. The management server allows users to participate and interact with other users in order to share comments and view videos that other users have suggested, viewed, favorite, etc. Communities of users may be formed as well as other types of user to user contacts, e.g., friends, family, etc. Video content may be used as a social tool or connection among users. The management server may send user interface layout information or the actual user interface screen to the user device when a user selects certain options or functions via the user device, the user device may display a user interface screen 1200 that has social networking aspects that involve activities among users that have registered EDDs, e.g., a user may follow shows, videos that other users have suggested, viewed, or marked as favorites, etc. 1201, listings of videos that are popular with other users may be displayed 1202, etc. The user may make selections of videos from the user interface screen which the user device relays to the management server (note that the ability of the user to control characteristics/behavior of the EDD via the user interface on the user device is inherent to the following discussions of the user interface). The management server may contact the EDD to instruct the EDD to retrieve the video using identification information supplied by the management server. The EDD may retrieve the video from a website, another user's cache, etc., in order to display the video to the user via a display device.

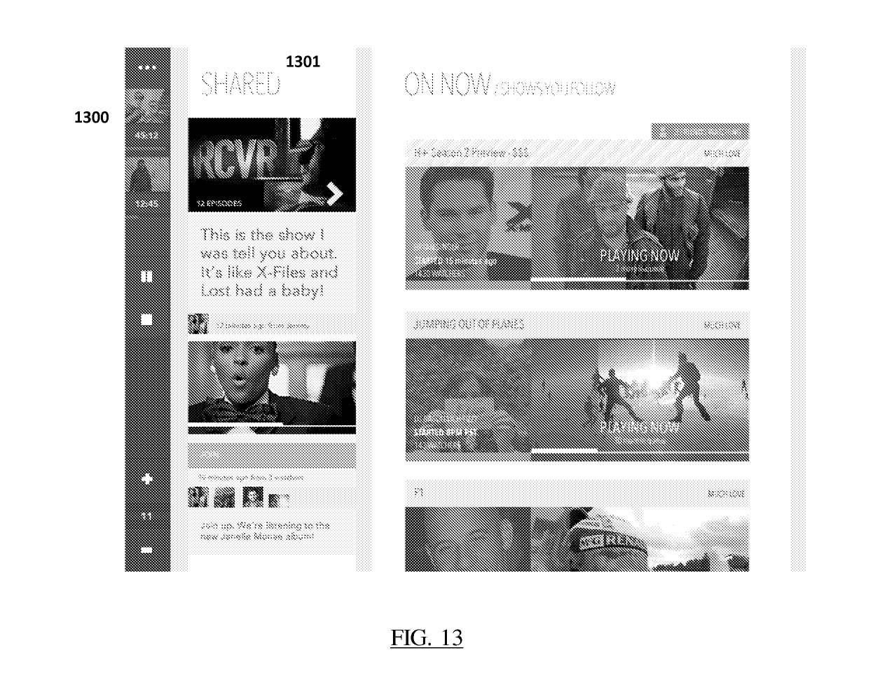

Referring to FIG. 13, a user interface screen 1300 is shown that may be displayed on a user device 701. The user interface screen 1300 displays videos and text that are shared by other users 1301, other users' comments may be displayed in a form that allows a user to associate other users with particular video content. Groups of videos may also be shared by other users, as well as groups of videos shared by groups of other users. The system may use information gathered from its databases, metadata licensed/purchased from others by the service/system, external feeds, aggregated usage patterns of the service/system user base, etc., to form groups of users, determine groups of videos, etc. A user may scroll through the videos and comments and select one of the videos to be displayed. Information regarding the selection is sent by the user device to the management server. The management server receives the selection and can send a URL to the EDD for the EDD to stream or download.

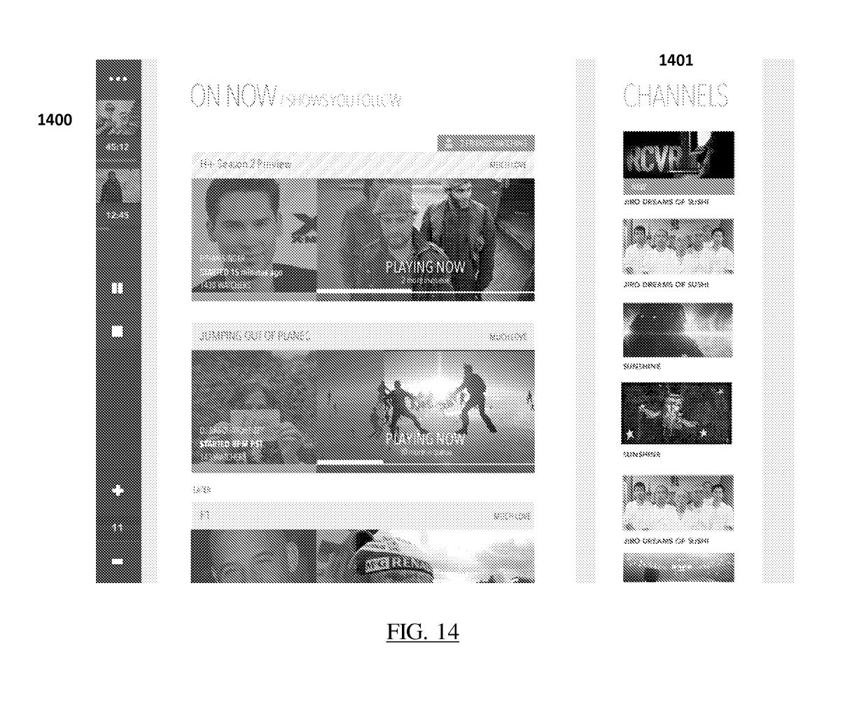

Referring to FIG. 14, a user interface screen 1400 is shown that may be displayed on a user device 701. The user interface screen 1400 displays video channels 1401 (e.g., channel metaphors representing URLs/websites, groups of videos, etc.) that a user may select to view. The videos in the channel may be presented/displayed in a specific order to represent a cohesive channel concept.

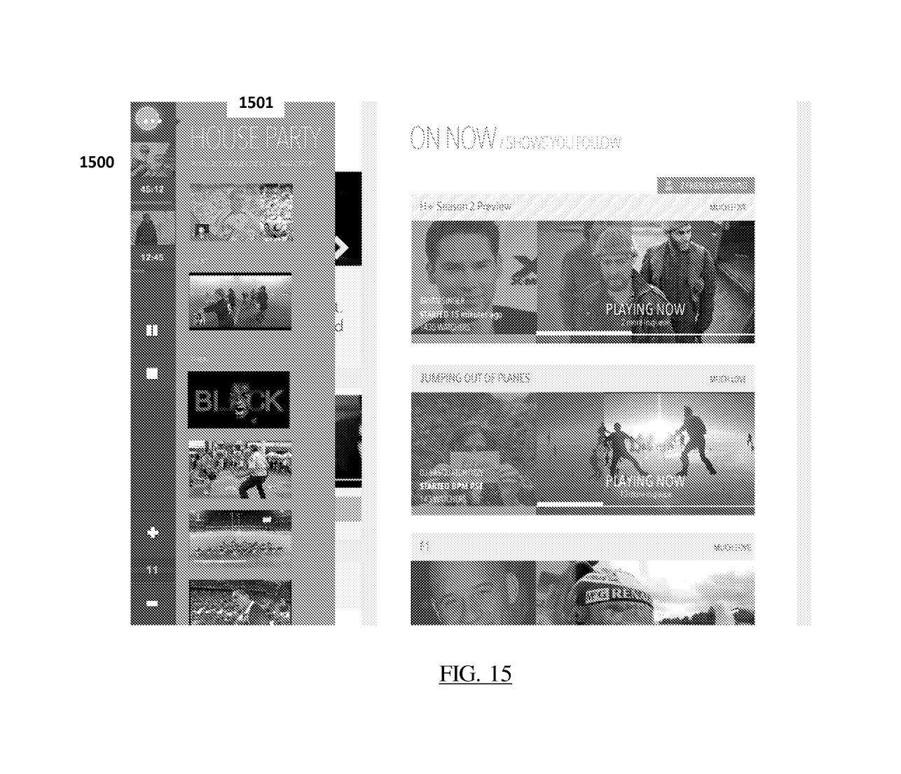

Referring to FIG. 15, a user interface screen 1500 is shown that may be displayed on a user device 701. The user interface screen 1500 displays a DJ feature where a user may subscribe to another user's DJ session. Users may watch another user host a DJ session where the user plays videos in a live or real time fashion. The management server allows a user (DJ) to host a DJ session. The DJ places videos in queue. The queue may be replicated in the queue of each user that is viewing the DJ session. As described herein, the DJ may manipulate the queue and move a video within the queue, replace videos in the queue, override a currently playing video, etc. The user interface screen may display the queue (possibly in a scrollable list form) so the user can visualize the DJ's selections or simply display the currently playing video. Another portion of the user interface screen (not shown) may display comments from other users that are viewing the DJ session.

### 7.3.6 Configuring an EDD

A typical hurdle that arises when a user purchases or receives a consumer device that is to be inserted in to the user's home network is integrating the consumer device into the user's home network. An EDD 702 may need to be connected to the user's home WiFi network in order to operate. Configuration of the EDD 702 therefore requires that specific information regarding the user's network be transferred to the EDD 702. However, when a device lacks any traditional user input capabilities (e.g., no remote, no keyboard), configuration poses a particular challenge in order to ensure that non-technical users will be able to quickly and easily perform the configuration steps and begin using the device.

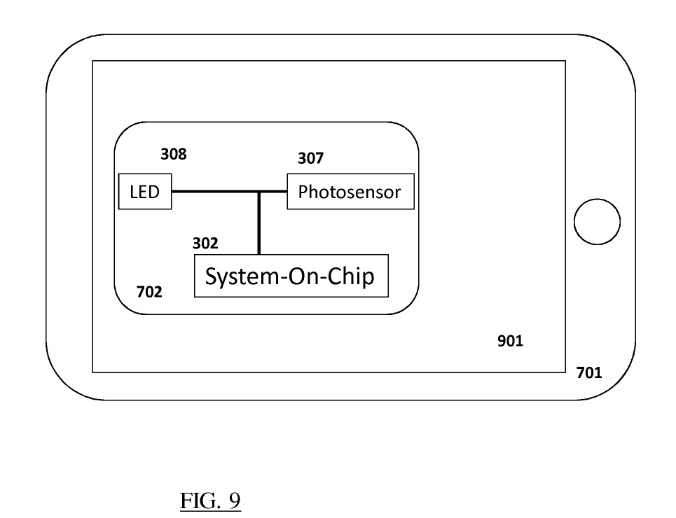

In an embodiment, an EDD 702 can be configured with WiFi network setup parameters (e.g. SSID, password, etc.), other information (e.g., the desired EDD “name”, etc.), etc., using a user device. Referring to FIG. 9, a user is asked to physically place the EDD 702 on top of the screen 901 of a user device 701, in this example the user device may be a tablet (smaller mobile devices may also work as well as larger stationary devices). A program on the user device 701 automatically detects the EDD 702, programs it using light pulses, and then communicates to the user that the process is complete. This solution avoids the need for establishing the WiFi hotspot. Instead, the user simply places the EDD 702 on top of a tablet screen and the tablet communicates the needed information to the EDD 702 via light pulses on the screen 901 measured by the light sensor 307.

The tablet 701 and EDD 702 may need to be calibrated before configuration. The EDD 702 can ensure that it understands the “lexicon” of the light levels being sent by the tablet. In the most limited scenario, the EDD 702 makes such determinations on an “open-loop” basis without any feedback to the tablet application. As such, the EDD 702 may need to watch the overall communication sequence multiple times before the calibration is complete and the data is interpreted properly. In another scenario, the system could communicate some basic information back to the user via the TV screen or LED output. In turn, the user would take this information and input it back into the tablet application to finalize the calibration.

In an embodiment, if the EDD 702 cannot negotiate the speed of the light patterns being presented by the tablet in any way, the light sequence can contain unique start and stop patterns that clearly delineate the boundaries of the communication. That way, should the EDD 702 need to view the overall sequence multiple times (for calibration or error-correction purposes), there is no chance that it would decode a data segment out of order or incompletely.

As different version EDDs are released, the tablet application can communicate advanced features available only to enhanced, future-generation hardware while still permitting the same sequence to work with original, first-generation hardware during the calibration process.

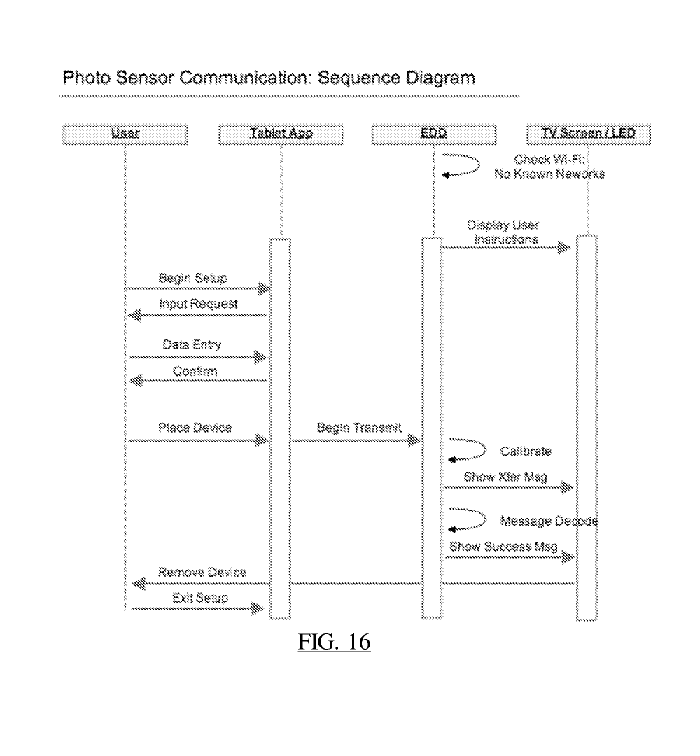

Detection of the EDD 702 could be a manual process (e.g., the user places the EDD on the tablet screen and then must tap a software button to continue) or it could be automatic based upon use of the capacitive touchscreen of the tablet. Referring to FIG. 16, an example communication sequence between the tablet application and the EDD 702 is shown that involves the manual process. For the automatic case, an embodiment of the EDD's bottom surface can contain a conductive material that can activate the touchscreen in such a way that the tablet application can detect its presence. Through this intelligent physical design, the procedure can proceed automatically, thus avoiding making the user tap the button. Likewise, the use of capacitive material on the EDD would also allow the tablet application to detect premature removal of the device from the tablet screen, allowing for quicker detection of potential error scenarios.

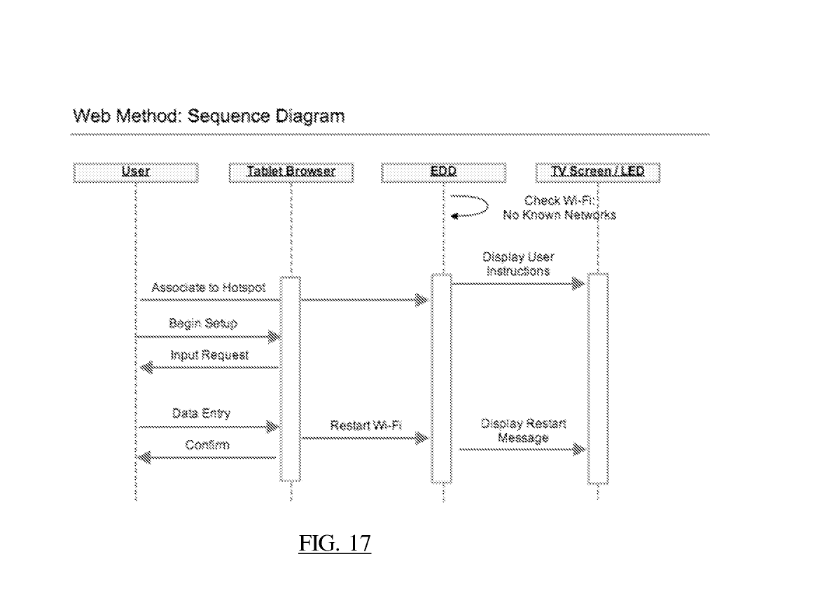

In an embodiment, a Web method may be used to configure the EDD 702. This solution leverages the EDD's ability to establish itself as an independent WiFi hotspot in the user's home. The EDD 702 uses a connected display device to ask the user to connect another device (e.g., a tablet, PC, etc.) to this temporary WiFi hotspot. Once connected, the user is then asked to direct the connected device's browser to a URL whereby the needed configuration parameters can be entered. Referring to FIG. 17, an example communication sequence between the device's browser and the EDD 702 is shown.

### 7.4 Discovery of EDDs in Certain Environment

In instances where the user device application is delivered as a Web application, discovery of EDD devices may be problematical. There are currently no standard interfaces available to Web applications for finding services advertised on the local network, such as an EDD.

If the EDD and user device are registered to the same user, the management servers may inform the user device of the EDD's local IP address. The user device may then attempt to contact the EDD service at that address, and if it succeeds, the EDD becomes available for control by the user device.

Another mechanism relies on a small application on the user device using the native APIs on the user device to find the EDD service. If found, the application can launch the Web application via the user device's native Web browser, passing the address(es) of the EDD device.

Certain user device manufacturers may choose to prohibit such an application due to various policies. If the EDD advertises its service via a standard protocol, such as Apple's Bonjour protocol, then the application might appear to be only a simple Bonjour service browser. However, if the EDD advertises its service as an HTTP service under Bonjour, then the application can simply launch the native Web browser with the appropriate URL matching the advertised service.

In all of these cases, the native Web browser can load an initial Web page from the EDD, which includes URLs for the management servers. This insures that the Web application can access both the EDD and the management servers together to allow full functionality of the application.

### 7.5 Functions Implemented in the Management Server

Referring again to FIG. 7, in an embodiment, the management server 703 can be responsible for supervising optimization and caching of multimedia content on behalf of the user, in response to a user request.

In an embodiment, the user device 701 and EDD 702 may optionally contain caching servers if they have sufficient storage available, and may optionally contain optimization servers if sufficient processing power and memory is available. The management server may forward an optimization request to optimization server 704 or, optionally, 701, 702, further directing the resulting optimized multimedia content item to caching server 705 or optionally the caching or playback servers in 701, 702.

In an embodiment, the management server 703 may implement algorithms that allocate optimization operations and caching across any of the available caching and optimization servers. For example, the user may desire that certain types of multimedia content items be cached on the user device 701 in order to guarantee that those items can be played back when the consumer is away from home, or a network connection to a caching server containing the desired items is not available. In another example, certain types of content may be directed to the EDD 702 for caching, in order to provide an optimal playback experience through a high-quality display system.

### 8. Optimization and Caching Management

Referring again to FIG. 7 and the previous discussion, in an embodiment, the user device 701 and EDD 702 may contain sufficient resources to support multiple roles as described in FIG. 1. For example, if user device 701 is a modern touch-screen tablet, it is likely to include multiple gigabytes of persistent storage, such as FLASH memory, that is suitable for storing multimedia content items, which is one of the possible functions of a caching server. Such devices often contain microprocessors and System-On-Chip (SOC) devices having great computational power as well as various specialized subsystems for handling multimedia content items. Such subsystems might include video decoders and encoders for MPEG and other video formats; if both encoding and decoding subsystems are available, the device may be capable of transcoding video, e.g., converting from one video or audio format to another, which is one of the possible functions of an optimization server. Similar considerations apply to the EDD device 702. In some cases the user may have multiple devices 701 and/or multiple EDD devices 702.

In an embodiment, a service provider may own and/or maintain optimization servers with much higher performance than a user device, and caching servers with much greater storage capacity than a user device. These servers may be shared resources that can perform optimization or caching for many users at once, either in a serial or parallel fashion. Such servers may have much higher availability than user devices. For example, the user may take his tablet with him on a trip, making its optimization or caching servers unavailable for use. It may be important to the user that a subset of the cached multimedia content items available to him is reliably present on his tablet, so that the subset may always be viewed regardless of network availability.

Given the availability of these various resources, it is possible to optimize how the resources are used to meet the desires and expectations of users of the system. The user generally decides between factors such as any combination of: latency, e.g., how soon will a multimedia content item be available for consumption; location, e.g., what device(s) will the user use to consume the item; and/or cost, e.g., how much is the user willing to pay to achieve the desired latency and location.

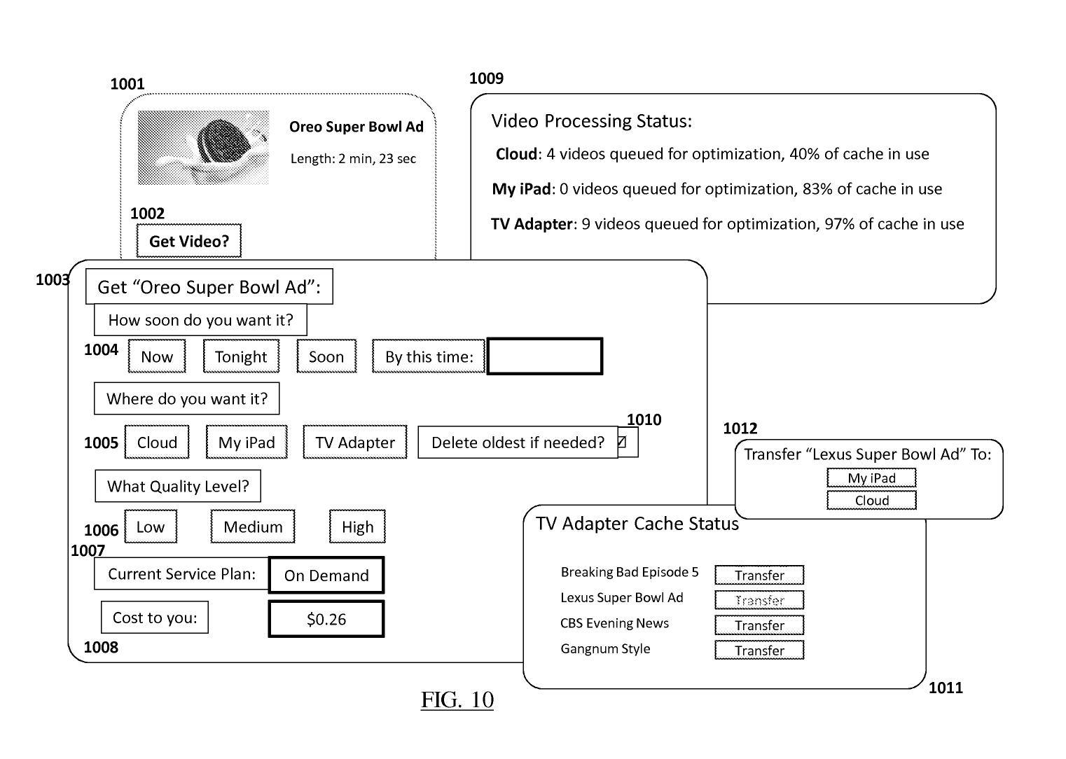

In an embodiment, referring also to FIG. 10, the user may indicate via a user interface on device 701 that a multimedia content item 1001 should be processed by the system by touching a button 1002, that may result in displaying a dialog 1003. The user can indicate how soon the item should be available 1004, where it should be available 1005, and what video quality he desires 1006. An indication 1007 can be given of the user's current service plan; in this example, “On Demand” means that the user is charged per video handled by the system. The final cost is shown 1008, which can be automatically updated by the user interface as the user makes his choices.

The management server may accept the user's choices and can calculate the final cost. In an embodiment, the management server attempts to achieve the least possible cost to the user. In this example, the choices “Tonight,” “My iPad,” and “High,” cause the server to direct an optimization server residing on the iPad to download the item, transcode it into a format suitable for display or playback on the iPad, and store it via the caching server on the iPad. The choice of “High” quality can mean that the iPad cannot optimize the video in real-time for immediate viewing, but the choice of “Tonight” can mean that slower processing of the item is acceptable.

In an embodiment, if the user had chosen “Now” instead of “Tonight”, the server might instead direct a service-based optimization server to immediately process the item and forward it to the caching server on the iPad, and the resulting final cost would be higher. The user might then chose the “Low” quality level, which can be processed in real-time on the iPad, and the server could direct the optimization as previously described, resulting in a lower final cost.

In an embodiment, the user interface may also display the current status 1009 of the user's choices and available caching servers. Seeing that the storage on the iPad is nearly filled, the user may check the “Delete oldest” checkbox 1010, indicating that the item should replace the oldest items on the iPad, if necessary.

In an embodiment, a subscription service plan can be displayed, where, for example, the only choice in 1004 is “Soon” and the only choice of quality 1006 is “Medium”, and cost to the user may not be displayed. In this case, the management server may choose optimization and cache servers based on the least cost to the service provider. For example, delaying some optimization and caching until late at night may result in lower bandwidth costs and better utilization of server capacity.

In an embodiment, various levels of subscription service may be provided. A “premium” service might support all options at a fixed cost per month.

In an embodiment, the service provider may, for example, support no service-based optimization and caching, directing all requests solely to the user devices. While this minimizes ongoing cost to the user (the service may in fact be provided at no charge), it can be inconvenient for the user. For example, an iPad cannot perform optimization and caching in the background or while it is asleep, and the user may need to periodically invoke an application to perform these tasks. If instead an EDD 702 is available, the service might direct all optimization and caching requests to it, and possibly charge only a nominal service fee.

In an embodiment, the user interface may display a status display 1011 showing cached items on any of the caching servers available to the user. Such a display may include an option 1012 to transfer cached items from one caching server to another. For example, items could be transferred from the EDD to the iPad at high speed, so that the item can be viewed on the iPad at any time. In some embodiments, the user may use the user interface to manually request optimization or caching of content items rather than relying on a management server.

In an embodiment, the management server may, for example, always use service provider optimization and caching servers for user selected items. Once items are cached on one or more service provider caching servers, the management server may direct a transfer of one or more items from one or more of the service provider's caching servers to a caching server located on a user device as opportunity permits. As an example, as items are cached by the service provider on the service provider's caching server(s), the management server may send a notification to the user's iPad indicating new items are available; the user may then launch an application containing a caching server which then can handle transfer of the item(s) to the iPad from one or more of the service provider's caching servers. In another example, an EDD 702 may not be powered on or connected to the network when an item becomes available; when it later is able to contact the management server, cached item(s) can be transferred to it from one or more of the service provider's caching servers.

In an embodiment, once one or more items are transferred from one caching server to another, they are deleted from the source caching server.

In an embodiment, the user may direct certain kinds of multimedia content items to different caching servers available to him. For example, he might direct all items that are movies or television programs to his EDD 702. Other video, for example short-form video from YouTube or other websites, might always be directed to his iPad. The items may be directed to various caching servers based on many different parameters, e.g., genre, length, quality, keywords present in metadata, etc. In determining the most cost effective delivery of an item to a caching server, the management server may choose optimization servers based on their relation to a caching server. For example, if the user has both an iPad and an EDD, optimization might always be directed to the same device as the ultimate caching server.

In an embodiment, an individual user of the system may also be a source of video, in that he may upload video streams he has created or otherwise collected. A user may have multimedia content items already present on a user device, such as 701 or a personal computer. These may have been obtained in a number of different ways, perhaps via a personal video camera or downloaded from a website. Such video streams are increasingly ubiquitous, as most modern mobile devices include cameras and software that allow the simple capture of video at the user's discretion.

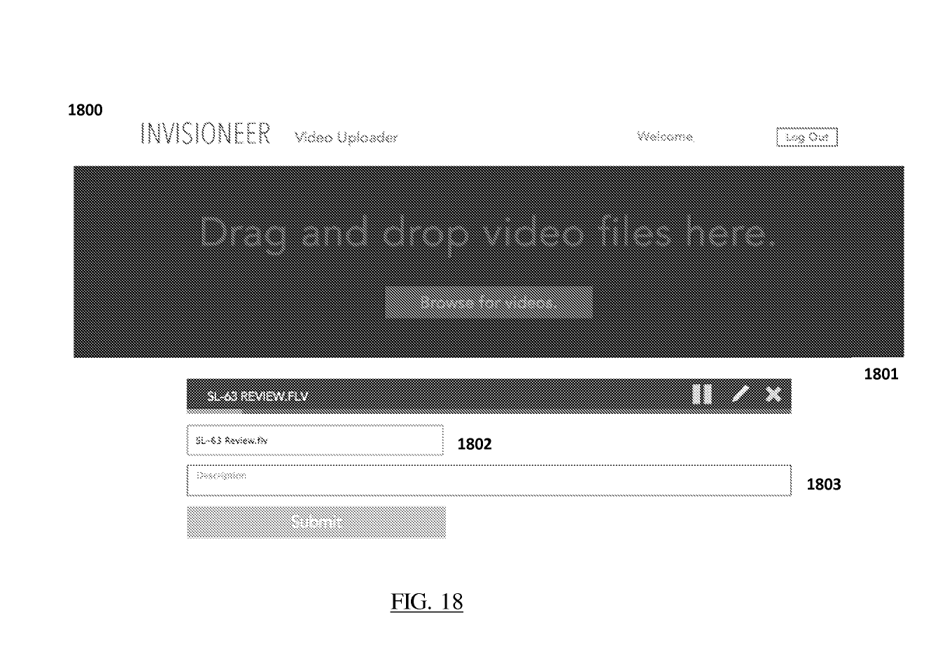

Referring to FIG. 18, either by visiting a particular URL or within a version of the mobile application, the user is provided a user interface 1800 that allows a video to be uploaded. The user may drag and drop videos onto an area 1801 of the user interface. The user may also enter interesting metadata for the video, such as a title 1802 and description 1803. The video may be uploaded to a holding area supplied by the service, a metadata descriptor created for it, and the video added to the user's bin for uploaded video. The video itself may be queued for optimization and caching as previously described, to be treated the same as any other video stream within the system. If the user device is a personal computer, optimization and caching may take place directly on the computer, which is then accessed by a playback server for viewing.

### 8. User and Device Registration

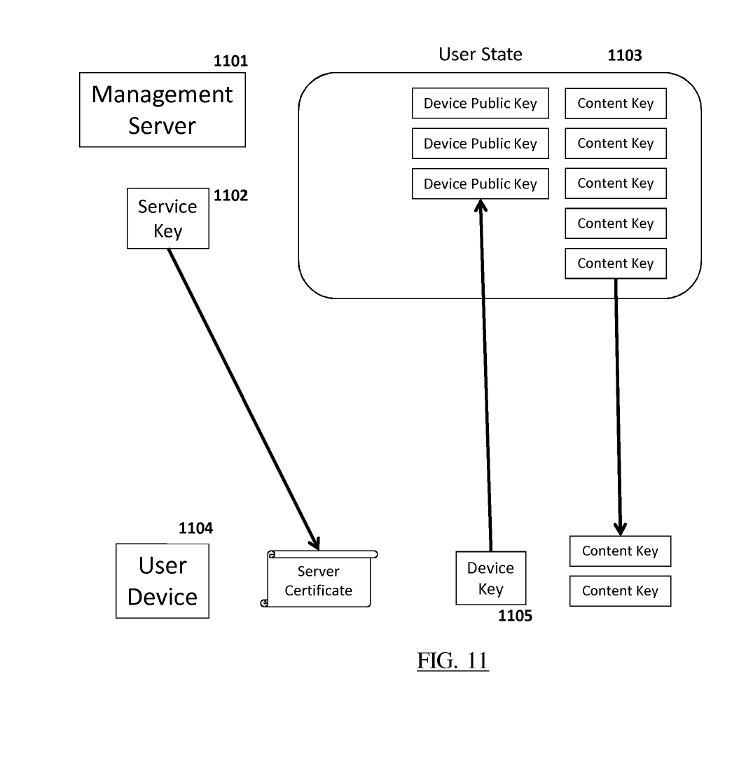

FIG. 11 illustrates an embodiment of the invention for managing user devices. Management server 1101 can be responsible for any combination of: validating users and their devices, registering new devices, or authenticating service delivery. The management server may store a unique public/private service key 1102 generated using a well-known cryptographic algorithm, e.g., RSA 2048, etc. The service key can be stored securely, and used to cryptographically sign certificates identifying the management server. When a new user is added to the system, a new User State container 1103 can be created and initialized.

In an embodiment, when the user requests registration of a new device 1104, the application on the device generates a unique device key 1105. The device key is a public/private key pair generated using a suitable public key algorithm, such as used for the service key. It passes the public key to the management servers for storage in the user state 1103, and stores the device key in a suitably secure manner on the local device. Additionally, the management server can use the service key 1102 to sign a certificate, that can be used by the device to verify the authenticity of the management servers during communications, and providing that certificate to the user device.

All further communication between the management server and user device may take place over secured HTTPS connections. These secured connections can be authenticated in both directions, for example, the client uses the stored certificate from the management server to validate that it is indeed communicating with the management server. During HTTPS negotiation the management server retrieves the public key for the device and validates that it is communicating with the proper device, otherwise it denies services.

### 9. Securing Cached Content

In an embodiment, it may be desirable to encrypt multimedia content items stored on user devices.

Referring again to FIG. 11, in an embodiment, each time that the user requests caching of a multimedia content item, the management server may generate a unique secret key suitable for use with a strong encryption algorithm, such as AES 128, and store it in the user state 1103, associating it with the multimedia content item. This key is called a content key.

In an embodiment, when the management server dispatches the multimedia content item to an optimization server, the content key can be forwarded to the optimization server as well. After optimization, the optimized multimedia content item can be encrypted with the content key before forwarding to a caching or playback server. The optimization server then can discard its copy of the content key.

In an embodiment, the management server may, for example, only use optimization servers that are controlled by the service provider. Thus, caching servers would not be presented with unencrypted multimedia content items.

In an embodiment, in order to play back an encrypted multimedia content item from an optimization or caching server, the playback server must contact the management server and request a copy of the content key, which it uses to decrypt the item for playback.

In an embodiment, the management server might download content keys for multimedia content items in a particular caching server to that server. For example, content keys might be provided to a mobile user device so that cached multimedia content items can be played back when an Internet connection is not available.

In an embodiment, after optimization, the content key can instead be forwarded to a caching server along with the encrypted multimedia content item, whence the caching server stores the key securely. When the multimedia content item is forwarded to another caching server or to a playback server, it forwards the content key as well.

In an embodiment, the management server does not, for example, generate or store content keys. Instead, the optimization server generates a content key, and securely stores or forwards the content key along with the multimedia content item. The content key may not be stored in the user state 1103.

In an embodiment, content keys may be selectively forwarded to certain caching servers and not to others, based on a characteristic of the caching server. For example, content keys might not be forwarded to an untrusted caching server.

In an embodiment, the management server only, for example, uses optimization and caching servers that run on user devices.

### 11. Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

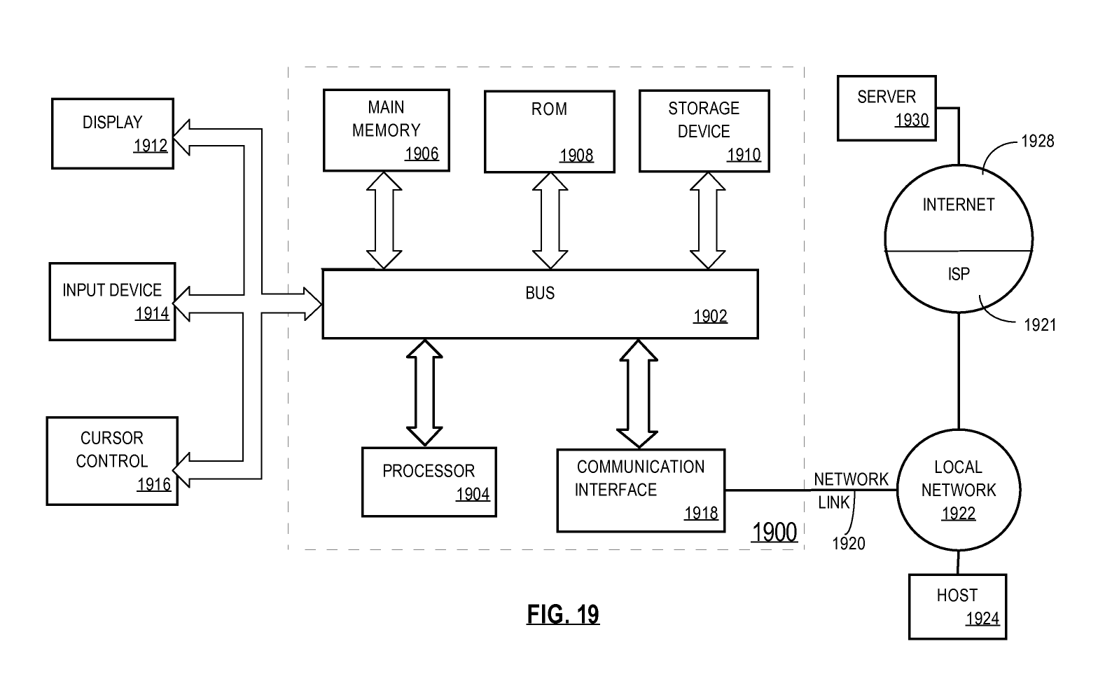

For example, FIG. 19 is a block diagram that illustrates a computer system 1900 upon which an embodiment of the invention may be implemented. Computer system 1900 includes a bus 1902 or other communication mechanism for communicating information, and a hardware processor 1904 coupled with bus 1902 for processing information. Hardware processor 1904 may be, for example, a general purpose microprocessor.

Computer system 1900 also includes a main memory 1906, such as a random access memory (RAM) or other dynamic storage device, coupled to bus 1902 for storing information and instructions to be executed by processor 1904. Main memory 1906 also may be used for storing temporary variables or other intermediate information during execution of instructions to be executed by processor 1904. Such instructions, when stored in non-transitory storage media accessible to processor 1904, render computer system 1900 into a special-purpose machine that is device-specific to perform the operations specified in the instructions.

Computer system 1900 further includes a read only memory (ROM) 1908 or other static storage device coupled to bus 1902 for storing static information and instructions for processor 1904. A storage device 1910, such as a magnetic disk or optical disk, is provided and coupled to bus 1902 for storing information and instructions.

Computer system 1900 may be coupled via bus 1902 to a display 1912, such as a liquid crystal display (LCD), for displaying information to a computer user. An input device 1914, including alphanumeric and other keys, is coupled to bus 1902 for communicating information and command selections to processor 1904. Another type of user input device is cursor control 1916, such as a mouse, a trackball, or cursor direction keys for communicating direction information and command selections to processor 1904 and for controlling cursor movement on display 1912. This input device typically has two degrees of freedom in two axes, a first axis (e.g., x) and a second axis (e.g., y), that allows the device to specify positions in a plane.

Computer system 1900 may implement the techniques described herein using device-specific hard-wired logic, one or more ASICs or FPGAs, firmware and/or program logic which in combination with the computer system causes or programs computer system 1900 to be a special-purpose machine. According to one embodiment, the techniques herein are performed by computer system 1900 in response to processor 1904 executing one or more sequences of one or more instructions contained in main memory 1906. Such instructions may be read into main memory 1906 from another storage medium, such as storage device 1910. Execution of the sequences of instructions contained in main memory 1906 causes processor 1904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1910. Volatile media includes dynamic memory, such as main memory 1906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1902. Transmission media can also take the form of acoustic or light waves, such as those generated during radio-wave and infra-red data communications.

Various forms of media may be involved in carrying one or more sequences of one or more instructions to processor 1904 for execution. For example, the instructions may initially be carried on a magnetic disk or solid state drive of a remote computer. The remote computer can load the instructions into its dynamic memory and send the instructions over a telephone line using a modem. A modem local to computer system 1900 can receive the data on the telephone line and use an infra-red transmitter to convert the data to an infra-red signal. An infra-red detector can receive the data carried in the infra-red signal and appropriate circuitry can place the data on bus 1902. Bus 1902 carries the data to main memory 1906, from which processor 1904 retrieves and executes the instructions. The instructions received by main memory 1906 may optionally be stored on storage device 1910 either before or after execution by processor 1904.

Computer system 1900 also includes a communication interface 1918 coupled to bus 1902. Communication interface 1918 provides a two-way data communication coupling to a network link 1920 that is connected to a local network 1922. For example, communication interface 1918 may be an integrated services digital network (ISDN) card, cable modem, satellite modem, or a modem to provide a data communication connection to a corresponding type of telephone line. As another example, communication interface 1918 may be a local area network (LAN) card to provide a data communication connection to a compatible LAN. Wireless links may also be implemented. In any such implementation, communication interface 1918 sends and receives electrical, electromagnetic or optical signals that carry digital data streams representing various types of information.

Network link 1920 typically provides data communication through one or more networks to other data devices. For example, network link 1920 may provide a connection through local network 1922 to a host computer 1924 or to data equipment operated by an Internet Service Provider (ISP) 1926. ISP 1926 in turn provides data communication services through the world wide packet data communication network now commonly referred to as the “Internet” 1928. Local network 1922 and Internet 1928 both use electrical, electromagnetic or optical signals that carry digital data streams. The signals through the various networks and the signals on network link 1920 and through communication interface 1918, which carry the digital data to and from computer system 1900, are example forms of transmission media.

Computer system 1900 can send messages and receive data, including program code, through the network(s), network link 1920 and communication interface 1918. In the Internet example, a server 1930 might transmit a requested code for an application program through Internet 1928, ISP 1926, local network 1922 and communication interface 1918.

The received code may be executed by processor 1904 as it is received, and/or stored in storage device 1910, or other non-volatile storage for later execution.

### 12. Equivalents, Extensions, Alternatives and Miscellaneous

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving a request to store a video content;
retrieving the requested video content from a source via the Internet;
storing the retrieved video content in a user specific cache, the user specific cache residing in at least one cloud based storage device.

2. The method as recited in claim 1, wherein the video content is streaming content.

3. The method as recited in claim 1, further comprising:
automatically transcoding the stored video content from a first format to a second format.

4. The method as recited in claim 1, further comprising:
automatically transcoding the retrieved video content from a first format to a second format before the storing the retrieved video content.

5. The method as recited in claim 1, further comprising:
recognizing segments of the retrieved video content;
wherein the storing step stores the retrieved video content without the recognized segments.

6. The method as recited in claim 1, further comprising:
detecting URL references to video content in a website;
processing detected URL references into content descriptors;
causing the content descriptors to be displayed for a user;
wherein the receiving step receives the request to store a video content in response to a user selection of a displayed content descriptor.

7. The method as recited in claim 1, wherein the source is a user's device.

8. The method as recited in claim 1, wherein the source is a user's local storage.

9. The method as recited in claim 1, wherein the source is a content server.

10. The method as recited in claim 1, further comprising:
in response to receiving the request to store a video content, placing the request to store a video content into a user specific queue of requests to store video content.

11. The method as recited in claim 1, wherein the retrieving step retrieves a requested video content in response to detecting that at least one request to store video content has been placed in a user specific queue of requests to store video content.

12. The method as recited in claim 1, wherein the retrieving step retrieves a requested video content in response to detecting that the requested video has become available.

13. The method as recited in claim 1, wherein the at least one of the at least one cloud based storage device is any combination of: supplied by a user or supplied by a service.

14. The method as recited in claim 1, further comprising:
creating content descriptors for each video content stored in the user specific cache;
causing the content descriptors to be displayed to a user;
in response to a user selection of a video content associated with a displayed content descriptor, retrieving the selected video content from the at least one cloud based storage device.

15. The method as recited in claim 1, further comprising:
receiving a request to play a video content stored in the user specific cache;
placing the request to play the video content in a playback queue;
causing video content associated with each request in the playback queue to be played.

16. The method as recited in claim 1, wherein a user is charged a fee for storing the retrieved video content in a user specific cache.

17. A non-transitory computer readable medium, storing software instructions, which when executed by one or more processors cause performance of:
receiving a request to store a video content;
retrieving the requested video content from a source via the Internet;
storing the retrieved video content in a user specific cache, the user specific cache residing in at least one cloud based storage device.

18. The non-transitory computer readable medium as recited in claim 17, wherein the video content is streaming content.

19. The non-transitory computer readable medium as recited in claim 17, further comprising:
automatically transcoding the stored video content from a first format to a second format.

20. The non-transitory computer readable medium as recited in claim 17, further comprising:
automatically transcoding the retrieved video content from a first format to a second format before the storing the retrieved video content.

21. The non-transitory computer readable medium as recited in claim 17, further comprising:
recognizing segments of the retrieved video content;
wherein the storing step stores the retrieved video content without the recognized segments.

22. The non-transitory computer readable medium as recited in claim 17, further comprising:
detecting URL references to video content in a website;
processing detected URL references into content descriptors;
causing the content descriptors to be displayed for a user;
wherein the receiving step receives the request to store a video content in response to a user selection of a displayed content descriptor.

23. The non-transitory computer readable medium as recited in claim 17, wherein the source is a user's device.

24. The non-transitory computer readable medium as recited in claim 17, wherein the source is a user's local storage.

25. The non-transitory computer readable medium as recited in claim 17, wherein the source is a content server.

26. The non-transitory computer readable medium as recited in claim 17, further comprising:
in response to receiving the request to store a video content, placing the request to store a video content into a user specific queue of requests to store video content.

27. The non-transitory computer readable medium as recited in claim 17, wherein the retrieving step retrieves a requested video content in response to detecting that at least one request to store video content has been placed in a user specific queue of requests to store video content.

28. The non-transitory computer readable medium as recited in claim 17, wherein the retrieving step retrieves a requested video content in response to detecting that the requested video has become available.

29. The non-transitory computer readable medium as recited in claim 17, wherein the at least one of the at least one cloud based storage device is any combination of: supplied by a user or supplied by a service.

30. The non-transitory computer readable medium as recited in claim 17, further comprising:
creating content descriptors for each video content stored in the user specific cache;
causing the content descriptors to be displayed to a user;
in response to a user selection of a video content associated with a displayed content descriptor, retrieving the selected video content from the at least one cloud based storage device.

31. The non-transitory computer readable medium as recited in claim 17, further comprising:
receiving a request to play a video content stored in the user specific cache;
placing the request to play the video content in a playback queue;
causing video content associated with each request in the playback queue to be played.

32. The non-transitory computer readable medium as recited in claim 17, wherein a user is charged a fee for storing the retrieved video content in a user specific cache.

33. An apparatus, comprising:
a subsystem, at a server, implemented at least partially in hardware, that receives a request to store a video content;
a subsystem, at the server, implemented at least partially in hardware, that retrieves the requested video content from a source via the Internet;
a subsystem, at the server, implemented at least partially in hardware, that stores the retrieved video content in a user specific cache, the user specific cache residing in at least one cloud based storage device.

34. The apparatus as recited in claim 33, wherein the video content is streaming content.

35. The apparatus as recited in claim 33, further comprising:
a subsystem, implemented at least partially in hardware, that automatically transcodes the stored video content from a first format to a second format.

36. The apparatus as recited in claim 33, further comprising:
a subsystem, implemented at least partially in hardware, that automatically transcodes the retrieved video content from a first format to a second format before the storing the retrieved video content.

37. The apparatus as recited in claim 33, further comprising:
a subsystem, implemented at least partially in hardware, that recognizes segments of the retrieved video content;
wherein the storing subsystem stores the retrieved video content without the recognized segments.

38. The apparatus as recited in claim 33, further comprising:
a subsystem, implemented at least partially in hardware, that detects URL references to video content in a website;
a subsystem, implemented at least partially in hardware, that processes detected URL references into content descriptors;
a subsystem, implemented at least partially in hardware, that causes the content descriptors to be displayed for a user;
wherein the receiving subsystem receives the request to store a video content in response to a user selection of a displayed content descriptor.

39. The apparatus as recited in claim 33, wherein the source is a user's device.

40. The apparatus as recited in claim 33, wherein the source is a user's local storage.

41. The apparatus as recited in claim 33, wherein the source is a content server.

42. The apparatus as recited in claim 33, further comprising:
in response to receiving the request to store a video content, placing the request to store a video content into a user specific queue of requests to store video content.

43. The apparatus as recited in claim 33, wherein the retrieving subsystem retrieves a requested video content in response to detecting that at least one request to store video content has been placed in a user specific queue of requests to store video content.

44. The apparatus as recited in claim 33, wherein the retrieving subsystem retrieves a requested video content in response to detecting that the requested video has become available.

45. The apparatus as recited in claim 33, wherein the at least one of the at least one cloud based storage device is any combination of: supplied by a user or supplied by a service.

46. The apparatus as recited in claim 33, further comprising:
a subsystem, implemented at least partially in hardware, that creates content descriptors for each video content stored in the user specific cache;
a subsystem, implemented at least partially in hardware, that causes the content descriptors to be displayed to a user;
a subsystem, implemented at least partially in hardware, that, in response to a user selection of a video content associated with a displayed content descriptor, retrieves the selected video content from the at least one cloud based storage device.

47. The apparatus as recited in claim 33, further comprising:
a subsystem, implemented at least partially in hardware, that receives a request to play a video content stored in the user specific cache;
a subsystem, implemented at least partially in hardware, that places the request to play the video content in a playback queue;
a subsystem, implemented at least partially in hardware, that causes video content associated with each request in the playback queue to be played.

48. The apparatus as recited in claim 33, wherein a user is charged a fee for storing the retrieved video content in a user specific cache.
